(19) United States
(12) Patent Application Publication
(10) Pub. No.: US 2009/0139165 A1
(43) Pub. Date: Jun. 4, 2009

(54) Insulating glass unit

(75) Inventors: James G. Prete, Chicago, IL (US); James A. Schneider, Hudson, OH (US)

Correspondence Address: Fay Sharpe LLP, 1228 Euclid Avenue, 5th Floor, The Halle Building, Cleveland, OH, 44115, US

(73) Assignee: Intigral, Inc.

(21) Appl. No.: 11/999,200

(22) Filed: Dec. 4, 2007

(51) Int. Cl. E06B 3/667

(52) U.S. Cl. 52/204.593; 52/745.2

(57) ABSTRACT

An insulating unit that includes at least three transparent and/or semi-transparent sheets and which includes an improved arrangement to secure one or more intermediate sheets to a spacer frame.

The present invention is directed to frames that include multiple panes or sheets of glass, and more particularly to a frame that includes three or more panes or sheets of glass. The frame of the present invention includes a pair of outer glass panes or sheets that are separated by and secured to a spacer frame, and one or more interior or intermediate glass panes or sheets are mounted between and spaced from the outer glass panes or sheets to form an insulating glass unit.

### BACKGROUND OF THE INVENTION

Multi-glass sheet arrangements are well known in the art. Several examples of such multi-glass sheet arrangements are disclosed in U.S. Pat. Nos. 7,241,352; 6,886,297; 6,715,244; 6,477,812; 6,415,561; 6,345,485; 6,289,614; 6,250,026; 6,223,414; 6,115,989; 5,813,191; 5,775,393; 5,675,944; 5,655,282; 5,644,894; 5,617,699; 5,601,677; 5,564,631; 5,553,440; 5,531,047; and 4,149,348, all of which are incorporated herein by reference.

U.S. Pat. Nos. 6,223,414 and 5,655,282 disclose a thermal insulating glass frame that includes at least three panes or sheets of glass and a spacer frame that are positioned between the panes of glass. This glass frame construction forms dead air spaces between adjacent glass panes so as to eliminate gas movement or gas currents moving from the compartment between the middle glass pane and one of the outer glass panes to the other compartment between the middle glass panes and the other outer glass pane. In the instance where there is gas movement between the first compartment and the second compartment, the thermal insulating properties of the glass frame are reduced. The arrangement to form the glass frame has limitations in that a spacer frame is provided between adjacent glass panes, thereby requiring the construction of two spacer frames for a glass frame having three panes of glass sheets and three spacer frames for a glass frame having four panes of glass.

U.S. Pat. Nos. 5,601,677; 5,564,631 and 5,531,047 disclose a glass frame that includes one or more inner glass panes spaced from and between a pair of outer glass panes. The outer glass panes are separated by and secured to a spacer frame having a generally U-shaped cross-sectional shape. Positioned on the base of the spacer frame is a layer of a pliable material having one or more grooves that is designed to receive edge portions of the inner glass panes. The glass frame is formed by positioning a spacer stock around edge portions of the inner panes of glass while moving the edge portions of the inner panes of glass into the grooves of the pliable material of the spacer frame. After the inner glass panes are positioned in the spacer frame, the outer panes of glass are secured to the outer surfaces of the spacer frame by a moisture-impervious sealant. The design of this glass frame has the advantage of a dead gas space between adjacent panes of glass and by use of only one spacer frame. Although the glass frame is an improvement over other glass frame designs, the glass frame has limitations. One limitation is that the moving or positioning of the edge portions of the inner panes of glass into the pliable material on the base of the spacer stock as the spacer stock is positioned around the inner panes of glass requires time and precision. Furthermore, the positioning of the spacer stock around the inner panes of glass can disturb the pliable material on the base of the spacer frame, thus making the glass frame look defective.

U.S. Pat. No. 5,644,894 discloses a glass frame that also includes one or more inner glass panes spaced from and between a pair of outer glass panes. The inner panes of glass are held in position by spaced rows of raised portions formed in the base of the spacer frame. The design of the glass frame has the advantage of a dead gas space between adjacent panes of glass. Although the glass frame is an improvement over other glass frame designs, the glass frame has limitations. One limitation is the requirement to provide spaced rows of raised portions in the base of the spacer frame that requires an extra step in the process of making the spacer frame. In addition, the mounting of the inner panes of glass between raised portions as the spacer stock is wrapped around the inner panes of glass requires time and precision.

U.S. Pat. No. 5,553,440 discloses a glass frame that is formed of three or more panes of glass. The glass frame includes a pair of outer glass panes separated by and adhered to outer opposed surfaces of a spacer frame having a generally U-shaped cross-section. A retaining member is mounted between the upright legs of the spacer frame has one or more grooves for receiving marginal and peripheral edge portions of one or more of the inner glass panes. The design of the glass frame has the advantage of a dead gas space between adjacent panes of glass. Although the glass frame is an improvement over other glass frame designs, the glass frame has limitations. One limitation is that the step of positioning the spacer stock around the inner panes of glass while moving the edge portions of the inner panes of glass into the grooves of the retaining members requires assembly time and precision.

U.S. Pat. Nos. 6,715,244; 6,477,812 and 6,345,485 disclose a glass frame that is formed of three or more panes of glass. The glass frame includes a pair of outer glass panes separated by and adhered to outer opposed surfaces of a spacer frame having a generally U-shaped cross-section. The design of the glass frame has the advantage of a dead gas space between adjacent panes of glass. Although the glass frame is an improvement over other glass frame designs, the glass frame has limitations. A complicated attachment arrangement for positioning one or more of the inner glass panes is required, which requires assembly time and precision.

In addition to the above discussed limitations associated with prior art insulating glass units, the prior art insulating glass units can have one or more of the following limitations, namely i) improper sealing of one or more of the interior or intermediate glass sheets of the insulating glass unit, ii) defects in the insulating glass unit, iii) space limitations that can occur when certain types of muntins are used, iv) improper placement of the muntin in the insulating glass unit, v) hand prints on one or more of the interior or intermediate sheets of glass, and/or vi) problems associated with edge light transmission by one or more of the interior or intermediate sheets of glass that can result in visual enhancement of flaws and/or create the perception of flaws on one or more sheets of glass.

In view of the current state of the art of multi-pane frame systems, there remains a need for an improved multi-pane frame system that is simple to manufacture, and which overcomes one or more of the past problems and/or limitations associated with multi-pane frame systems.

### SUMMARY OF THE INVENTION

The present invention is directed to an insulating glass unit (IGU) that includes multiple panes or sheets of glass wherein a pair of outer glass sheets are separated by and secured to a spacer frame, and one or more interior or intermediate glass sheets are mounted between and spaced from the outer glass sheets. The insulating glass unit of the present invention has one or more of the following advantages, namely a) a reduction in the number of seals required for the insulating glass unit, b) an increased durability and/or quality associated with the seals for the insulating glass unit, c) a reduced concern regarding the improper sealing of one or more of the interior or intermediate glass sheets of the insulating glass unit, d) a reduction in the number of defects or perceived defects in the insulating glass unit, e) the creation of asymmetrical airspaces between two or more sheets of glass, f) a reduction of sound transmission through the insulating glass unit, g) a reduction in thickness of the insulating glass unit, h) an ability to increase the space for a muntin between two sheets of glass without having to increase the thickness of the insulating glass unit, i) a reduction or elimination of errors resulting from improper insertion of the muntin in the insulating glass unit, j) an improvement in the aesthetics of the insulating glass unit, k) a reduction in the edge light transmission into one or more of the interior or intermediate sheets of glass, l) a reduction in material costs to form the insulating glass unit, m) a possible reduction in weight of the insulating glass unit, n) the ability to use different glass sheet thicknesses for one or more of the interior or intermediate glass sheets, o) providing a simple arrangement to secure one or more intermediate sheets of glass to the spacer frame so as to reduce time and/or costs associated with the manufacture of the insulating glass unit, and/or p) providing a simple arrangement to secure one or more intermediate sheets of glass to the spacer frame to enable the one or more intermediate sheets of glass to be assembled by an automated or semi-automated assembly line. The insulating glass unit of the present invention can have and/or exhibit one or more of the advantages set forth above.

In one non-limiting aspect of the present invention, there is provided an insulating glass unit that includes a pair of outer glass sheets that are separated from one another and secured to a spacer frame by an adhesive and/or sealant; however, it can be appreciated that a mechanical connection arrangement can be used as an alternative to or in conjunction with an adhesive and/or sealant to secure one or both outer glass sheets to the spacer frame. The outer glass sheets generally have a thickness of about 0.01-2 inches, typically about 0.04-1 inch, and even more typically about 0.125-0.5 inch; however, it will be appreciated that the outer glass sheets can have smaller or larger thicknesses. Generally, the thickness of the outer glass sheets is about the same; however, it can be appreciated that the thickness can be different. Generally, the type of glass used to form the outer glass sheets (e.g., tempered glass, non-tempered glass, colored glass, coated glass, laminated glass, etc.) is the same; however, it can be appreciated that one outer glass sheet can be different from the other outer glass sheet. Non-limiting examples of coated or colored glass sheets that can be used in the present invention are disclosed in U.S. Pat. Nos. 4,610,711; 4,806,220; 4,853,257; 4,170,460; 4,239,816; 4,873,206; 4,792,536; 5,030,593; and 5,240,866, all of which are incorporated herein by reference. Although the insulating glass unit of the present invention will be specifically described with reference to glass sheets, it will be appreciated that one or more or all of the glass sheets used to form the insulating glass unit can be substituted by other types of transparent or semi-transparent materials (e.g., plastic, etc.). One or more of the sheets of glass can include a coating (e.g., a solar control coating, emissivity coating, etc.) that can be applied in any conventional manner; however, this is not required. In one non-limiting embodiment of the invention, when an adhesive and/or sealant is used to at least partially secure one or both of the outer glass sheets to the spacer frame, a substance such as, but not limited to, one described in United States Statutory Invention H975, and U.S. Pat. Nos. 4,092,290; 4,109,431; 4,149,348; 4,215,164; 4,348,435; 4,431,691; 4,622,249; 4,807,419;4,807,439; 4,831,799; 4,873,803; 5,177,916; 5,531,047; 5,553,440; 5,601,677; 5,644,894; 5,655,282; 5,675,944; and/or 6,223,414, all of which are incorporated by reference herein, can be used. Non-limiting adhesives and/or sealants that can be used to at least partially form the insulating glass unit of the present invention include, but are not limited to, silicon adhesives, butyl rubber or other butyls, polysulfide, polyurethane, polyisobutylene, hot melts (i.e., butyl hot melts, etc.), etc. In another and/or alternative non-limiting embodiment of the invention, the adhesive and/or sealant used to at least partially form the insulating glass unit of the present invention is generally moisture and/or gas impervious; however, this is not required. In one non-limiting aspect of this embodiment, the adhesive and/or sealant used to at least partially secure the outer glass sheets to the spacer frame forms a substantially moisture impervious and gas impervious seal. As defined herein, a gas impervious seal is a seal that is measured using a European procedure identified as DIN 52293, wherein the seal can reduce the loss of fill gas to less than about 20% per year. Although this is the definition for a gas impervious seal, it will be appreciated that the insulated glass units of the present invention are not required to have one or more fill gases (e.g., nitrogen, air, argon, krypton, helium, etc.). As defined herein, a moisture impervious seal is a seal that has a moisture permeability of less than about 100 gm mm/M² per day as measure in accordance with ASTM F 372-73. In one non-limiting arrangement, the adhesive and/or sealant used on the insulating glass units of the present invention forms a gas impervious seal that can reduce the loss of fill gas to less than about 5% per year, and typically to less than about 1% per year. In another and/or alternative non-limiting arrangement, the adhesive and/or sealant used on insulating glass units of the present invention forms a moisture impervious seal that has a moisture permeability of less than about 20 gm mm/M² per day, and typically less than about 5 gm mm/M² per day. In still another and/or alternative non-limiting embodiment of the invention, one or more additional adhesive/sealant layers can be applied to the perimeter of the spacer frame after the two outer sheets are positioned on and/or secured to the spacer frame; however, this is not required. In one non-limiting arrangement, at least a portion of the outer edge of the insulated glass unit of the present invention includes a groove that is formed by the outer edges of the two outer sheets of glass and the outer surface of the spacer frame. The additional adhesive/sealant layer, when used, can be applied in the groove so as to at least partially fill in the groove; however, this is not required. The use of the additional adhesive/sealant layer can also or alternatively be used to improve the connection between at least one of the outer glass sheets and the spacer frame, increase the moisture resistance of the seal between at least one of the outer glass sheets and the spacer frame, and/or increase the gas imperviousness of the seal between at least one of the outer glass sheets and the spacer frame; however, this is not required. Many processes, methods and/or arrangements can be used to secure the outer two sheets of glass to a spacer frame. Non-limiting examples of processes, methods and/or arrangements that can be used in the present invention to secure the outer two sheets of glass to a spacer frame are disclosed in U.S. Pat. Nos. 3,919,023; 4,092,290; 4,109,431; 4,215,164; 4,348,435; 4,622,249; 4,807,419; 4,952,430; 5,177,916; 6,301,858; all of which are incorporated herein by reference.

In another and/or alternative non-limiting aspect of the present invention, the adhesive and/or sealant can be applied to the spacer frame and/or sheets of glass by a hand-operated process, a semi-automated process or an automated process. In one non-limiting aspect of the present invention, the adhesive and/or sealant can be applied under pressure. In such an arrangement, the adhesive/sealant is pumped from some source to a nozzle that is used to apply the adhesive and/or sealant to one or more sheets of glass and/or to the spacer frame. An operator and/or an automated control system can be used to adjust the flow rate of the adhesive and/or sealant to the one or more sheets of glass and/or to the spacer frame. Non-limiting examples of systems that can be used to apply the adhesive and/or sealant to the one or more sheets of glass and/or to the spacer frame are disclosed in U.S. Pat. Nos. 5,564,631; 6,630,028 and 7,048,964; and United States Patent Publication No. 2006/0093742, all of which are incorporated herein by reference.

In another and/or alternative non-limiting aspect of the present invention, there is provided an insulating glass unit that includes a desiccant. The desiccant is used to remove moisture that exists and/or absorbed in the sealed region formed by the two outer sheets of glass and the spacer frame. The desiccant absorbs moisture in the unit when it is originally assembled, and any moisture that gets in through the vapor barrier of the window during the life of the window. The desiccant can be located in one or more regions of the insulating glass unit. In one non-limiting embodiment of the invention, at least a portion of the desiccant can be secured to the spacer frame by an adhesive and/or sealant; however, this is not required. In one non-limiting aspect of this embodiment, a desiccant can be mixed with an adhesive and/or sealant that is used on the insulating glass unit; however, this is not required. In another and/or alternative non-limiting embodiment of the invention, the desiccant can be placed along one or more portions of an inner surface of the spacer frame; however, this is not required. When a desiccant is inserted on the spacer frame, the desiccant can be inserted on the spacer frame prior to, during and/or after the formation of the spacer frame. In still another and/or alternative non-limiting embodiment of the invention, when a desiccant is mixed with an adhesive and/or the sealant, such adhesive and/or sealant should be sufficiently permeable to moisture so that the desiccant in the adhesive and/or sealant is at least partially encapsulated by the adhesive and/or sealant can absorb moisture. In one non-limiting arrangement, the adhesive and/or sealant that is mixed with and/or at least partially encapsulates a desiccant has a moisture permeability of greater than about 2 gm mm/M² per day as measure in accordance with ASTM F 372-73. In yet another and/or alternative non-limiting embodiment of the invention, the desiccant can be applied to the spacer frame and/or other portion of the insulating glass unit by a hand-operated process, a semi-automated process or an automated process. In one non-limiting aspect of this embodiment, there is provided one or more desiccant dispensers to apply a desiccant or a desiccant and an adhesive and/or sealant to the spacer frame and/or to one or more other regions of the insulating glass unit. In one specific arrangement, the one or more desiccant dispensers apply a desiccant or a desiccant and adhesive and/or sealant to an inside surface of a channel in the spacer frame. Various automated arrangements can be used to apply a desiccant or a desiccant and adhesive to an inside surface of a channel in the spacer frame. One-limiting arrangement to apply a desiccant or a desiccant and adhesive to an inside surface of a channel in the spacer frame is disclosed in United States Patent Publication No. 2006/0037665, which is incorporated herein.

In still another and/or alternative non-limiting aspect of the present invention, there is provided an insulating glass unit that has a low thermal conductive path through the edge of the insulating glass unit. As such, the insulating glass unit exhibits a high resistance to heat loss, a long diffusion path and structural integrity with sufficient structural resilience to accommodate a certain degree of thermal expansion and contraction which can occur in several of the components of the insulating glass unit. In one non-limiting embodiment of the invention, the edge of the insulating glass unit has an average RES-value of at least about 10. The RES-value is measured using an ANSYS program that is disclosed and defined in U.S. Pat. No. 5,655,282, which is incorporated herein. In one non-limiting aspect of this embodiment, the edge of the insulating glass unit has an average RES-value of at least about 50. In another non-limiting aspect of this embodiment, the edge of the insulating glass unit has an average RES-value of at least about 100.

In yet another and/or alternative non-limiting aspect of the present invention, there is provided an insulating glass unit that includes a spacer frame that facilitates in the structural integrity of the insulating glass unit. The spacer frame can be formed of a variety of materials such as, but not limited to, a polymeric material (e.g., halogenated polymeric material such as polyvinylidene chloride, polyvinylidene fluoride, polyvinyl chloride polytrichlorofluoro ethylene, and/or the like), metal (e.g., stainless steel, galvanized steel, tin coated steel, aluminum, etc.), composite material, metal-clad plastic, metal-clad reinforced plastic, etc. The spacer frame is generally formed of a moisture impervious and/or gas impervious material; however, this is not required. The body of the spacer frame can be reinforced in one or more locations; however, this is not required. The spacer frame can have a variety of shapes and/or sizes for use in a number of different sized and/or typed insulating glass units. In one non-limiting embodiment of the invention, the spacer frame functions as an at least a partial barrier to gas entering and/or leaving the sealed compartment defined between the two outer glass sheets and the inner surface of the spacer frame. In another and/or alternative non-limiting embodiment of the invention, the spacer frame functions as an at least a partial barrier to moisture entering the sealed compartment defined between the two outer glass sheets and the inner surface of the spacer frame. In still another and/or alternative non-limiting embodiment of the invention, the spacer frame has sufficient structural strength and/or resiliency to keep the outer glass sheets spaced apart and to also accommodate a certain degree of thermal expansion and contraction which typically occurs in the several component parts of the insulating glass unit. In yet another and/or alternative non-limiting embodiment of the invention, the spacer frame has a generally U-shaped cross-section. As can be appreciated, the frame can have other or additional cross-sectional shapes along the longitudinal length of the spacer frame. In still yet another and/or alternative non-limiting embodiment of the invention, the spacer frame can be formed to have three continuous corners and a fourth corner that is designed to be connected together by a clamp, clip, solder, weld, rivet, screw, etc.; however, this is not required. In yet another and/or alternative non-limiting embodiment of the invention, the spacer frame can be fabricated by use of a mold, use of an extrusion process, and/or use of one or more forming rollers. Non-limiting examples for manufacturing a spacer frame that can be used in the present invention are disclosed in U.S. Pat. Nos. 3,105,274; 5,177,916; 5,255,481; 5,351,451; 5,501,013; 5,553,440; 5,601,677; 5,617,699; 5,644,894; 5,675,944; 5,761,946; 5,813,191; 6,115,989; 6,250,026; 6,345,485; 6,415,561; 6,470,561; and 7,021,110, all of which are incorporated herein by reference. In another and/or alternative non-limiting embodiment of the present invention, the spacer frame is at least partially formed of a strip of material that has moisture and gas impervious properties so as to maintain the insulating gas in the sealed compartment of the insulating glass unit, and/or prevent gas from entering the sealed compartment of the insulating glass unit, and to also inhibit or prevent the ingress of moisture into the sealed compartment of the insulating glass unit. The strip of material used to at least partially form the spacer frame can also be selected to have a structural integrity to maintain the outer glass sheets of the insulating glass unit in spaced relation to one another. In one non-limiting arrangement, the strip of material is a metal strip (e.g., stainless steel, tin-plated steel, aluminum, etc.) that has a thickness of about 0.004-0.25 inch, a width of about 0.3-2 inches and a length sufficient to make a spacer frame for the insulating glass unit of a predetermined shape and dimension. As can be appreciated, the strip of material can have other thicknesses and/or widths. Prior to, during and/or after the strip of material is formed in the spacer frame, a desiccant can be applied to the strip of material. In one non-limiting manufacturing process, a bead adhesive material that is moisture and gas pervious and which has been mixed with one or more desiccants is applied to one or more portions of the strip. In this manner, the desiccant can be contained in the adhesive material and secured to the strip. Non-limiting types of adhesives that can be used include, but are not limited to, polyurethane, silicone, and the like. When the desiccant and adhesive are applied to the strip of material, the mixture of adhesive and desiccant is generally applied to about the center of the strip by any convenient manner; however, this is not required. The strip of material with or without the bead of adhesive and desiccant is generally formed to have a single walled U-shaped configuration; however, it can be appreciated that other cross-sectional shapes can be used. The U-shape configuration of the spacer frame is generally formed by bending the outer edges of the strip by use of any convenient manner (e.g., forming rolls, etc.). When the desiccant and adhesive are to be applied to the strip of material after the strip of material is formed into a U-shape, the bead of desiccant and adhesive are generally applied to the inside of the U-shaped channel; however, this is not required. The U-shaped strip of material can be then formed into a spacer frame. Notches can be cut in the strip of material to facilitate in the formation of one or more continuous corners of the spacer frame. In one non-limiting process for forming a spacer frame, the spacer can be prefabricated to have a first end with a tapered configuration that is suitable to fit within the profile of a second end when the spacer frame is bent such that the opposing ends of the space frame are adjacent one another; however, this is not required. Each opposing side of the formed strip of material can have one or more inwardly directed projections or wings; however, this is not required. The wings, when used, may or may not extend within the tapered configuration of the first end of the spacer frame. One or more access holes can be prefabricated or formed in the spacer frame such that when the spacer frame is assembled, at least one access hole aligns with another hole to form an access passage positioned on the spacer frame; however, this is not required. One or more ends of the spacer frame can be angled; however, this is not required. The one or more access openings can be used to insert a gas into the insulating glass unit; however, this is not required. The spacer frame can include one or more perforations along the length of the strip to facilitate in forming corners for the spacer frame; however, this is not required. A punch assembly can be used to form the one or more perforations; however, this is not required.

In still yet another and/or alternative non-limiting aspect of the present invention, there is provided an insulating glass unit that includes a sealed compartment defined between the two outer glass sheets and the inner surface of the spacer frame, and wherein the sealed compartment includes one or more insulating gasses (e.g., argon, krypton, argon-krypton mixture, argon-nitrogen mixture, argon-air mixture, nitrogen, air, air-krypton mixture, nitrogen-krypton mixture, helium, etc.); however, this is not required.

In another and/or alternative non-limiting aspect of the present invention, there is provided an insulating glass unit that includes one or more “muntins” or “muntin bars.” Typically, the one or more muntins or muntin bars are positioned between the outer sheets of glass; however, this is not required. When the one or more muntins or muntin bars are positioned between the outer sheets of glass, the one or more muntins or muntin bars are secured to or otherwise engage the spacer frame of the insulating glass unit; however, this is not required. The muntins or muntin bars can be formed into a variety of shapes and/or be made of a variety of materials to form distinctive grid patterns for use in an insulating glass unit. The muntins or muntin bars can have different colors and/or patterns on different sides of the muntins or muntin bars; however, this is not required. The construction of the muntin bar grids can be accomplished by a hand-operated process, a semi-automated process or an automated process. In one non-limiting embodiment of the present invention, the construction of a muntin or muntin bar is an automated or semi-automated process wherein muntin bar stock is produced by roll forming a metal sheet material (e.g., aluminum, coated steel, stainless steel, etc.). The roll forming machine generally forms the sheet material into elongated muntin bar stock. The muntin bar stock can then be cut into lengths, notched and assembled into grids for use in the insulating glass units. The notching of the muntin stock can occur prior to, during and/or after the roll forming process. For example, a supply of sheet material can be fed to a forming device that includes a punching mechanism which forms one or more punched regions in the sheet material at defined locations. The punched sheet material can then be directed to one or more forming rollers to form the sheet material in the desired cross-sectional shape. The formed sheet material can then be cut to defined lengths so that the formed sheet material can be formed into the muntin. As can be appreciated, many other or alternative processes can be used to form the muntin for use in the present invention. Non-limiting processes for forming muntin stock and/or assembling muntins or muntin bars that can be used in accordance with the present invention are disclosed in U.S. Pat. Nos. 5,099,626; 5,313,761; 6,173,484; 6,244,012; 6,397,453; 6,438,819; 6,618,926; 6,678,938; 6,708,384; 6,745,460; 6,687,982; 6,708,384; 6,745,460; 6,889,416; and 6,912,767; and United States Patent Publication Nos. 2002/0056183; and 2004/0139592, all of which are incorporated by reference.

In still another and/or alternative non-limiting aspect of the present invention, there is provided an insulating glass unit that includes one or more “muntins” or “muntin bars” that include a mounting or orientation arrangement. In one non-limiting embodiment of the invention, the muntins or muntin bars and/or one or more other components of the insulating glass unit can include one or more mounting structures to facilitate in securing the muntins or muntin bars to the insulating glass unit. Many different structures can be used to facilitate in securing the muntins or muntin bars to the insulating glass unit (e.g., flanges, slots, openings, etc.). In one non-limiting aspect of this embodiment, the insulating glass unit includes a mounting structure on a spacer frame that is designed to engage with and/or be engaged by a structure on the muntins or muntin bars so that the muntins or muntin bars can be properly secured to and/or be properly oriented with the spacer frame. An adhesive and/or mechanical connector (e.g., latch, clip, pin, screw, rivet, etc.) can also be used to maintain the connection of the muntins or muntin bars to the spacer frame; however, this is not required. In another and/or alternative non-limiting aspect of this embodiment, the insulating glass unit includes a mounting structure on a mounting element that is connected to or connectable to the spacer frame. The mounting element is designed to engage with and/or be engaged by a structure on the muntins or muntin bars so that the muntins or muntin bars can be properly secured to and/or be properly oriented with the mounting element. An adhesive and/or mechanical connector (e.g., latch, clip, pin, screw, rivet, etc.) can be also used to maintain the connection of the muntins or muntin bars to the mounting element; however, this is not required. In another and/or alternative embodiment of the invention, the muntins or muntin bars and/or one or more other components of the insulating glass unit can include one or more orientation or keying structures to facilitate in properly orientating the muntins or muntin bars in the insulating glass unit. The one or more keying structures can be formed on one or more portions of the muntins or muntins bars, and/or be connected to the muntins or muntin bars. As mentioned above, the muntins or muntin bars can include designs on one or more of the faces of the muntins or muntin bars. These designs may require the muntins or muntin bars to be rotated or otherwise oriented in a certain way in the insulating glass unit so that the design on the muntins or muntin bars is properly displayed when the insulating glass unit is fully assembled. In addition, or alternatively, some muntins or muntin bars have different designs and/or colors on the different faces of the muntins or muntin bars. As such, not only must the proper orientation of the muntins or muntin bars be monitored when inserting the muntins or muntin bars in the insulating glass unit, but also the proper side of the muntins or muntin bars must be monitored to ensure that the face of the muntins or muntin bars is facing the proper way once the insulating glass unit is fully assembled. Improper muntins or muntin bars orientation in the insulating glass unit results in a defective product. The use of one or more orientations or keying structures in accordance with the present invention can be used to reduce such errors. As can be appreciated, the one or more orientation or keying structures can also be used to facilitate in securing the muntins or muntin bars to the insulating glass unit; however, this is not required. In one non-limiting aspect of this embodiment, one or more orientation structures are in the form of visual indicators that can be used on the muntins or muntin bars and/or on one or more components of the insulating glass unit to facilitate in the proper orientation of the muntins or muntin bars in the insulating glass unit. Such visual indicators can include, but are not limited to, colored markings, ribs, depressions, and/or other types of visual markings. In one non-limiting example, the muntins or muntin bars can include a colored marking to indicate that the muntins or muntin bars should be installed with the marking facing upward and/or the marking should be positioned at the top of the insulating glass unit. As can be appreciated, the marking on the muntins or muntin bars can have other or additional meanings to an installer and/or to an automated or semi-automated process. As also can be appreciated, one or more markings can alternatively or additionally be used on one or more components of the insulating glass unit (e.g., spacer frame, mounting element, etc.). In another and/or alternative non-limiting aspect of this embodiment, one or more orientations structures are in the form of keying type structures that require the muntins or muntin bars to be properly oriented relative to one or more other component of the insulating glass unit (e.g., spacer frame, mounting element, etc.) before the muntins or muntin bars can be secured to the insulating glass unit. The type and/or shape of such keying type structures is non-limiting. In one non-limiting design, the muntin or muntin bar in a certain location includes a flange that has a special configuration. The flange can be part of the muntin or muntin bar or can be an added element to the muntin or muntin bar that can be clipped or otherwise connected to the muntin or muntin bar (e.g., inserted into a slot, opening, etc. in the muntin or muntin bar, etc.). In addition, the spacer frame and/or mounting element that can be connected to the spacer frame also includes a specially configured cavity, opening and/or slot that is designed to receive the specially configured flange on the muntin or muntin bars. The specially configured flange on the muntin or muntin bars can be located in a certain region on the muntin or muntin bars; however, this is not required. Likewise, the specially configured cavity, opening and/or slot in the spacer frame and/or mounting element can be located in a certain region on the insulating glass unit; however, this is not required. The combination of the specially configured flange and the specially configured cavity, opening and/or slot can be used to ensure the proper positioning and/or orientation of the muntin or muntin bars in the insulating glass unit, and/or can be used to ensure that the muntin or muntin bars are facing upward and/or downward in the proper direction when the muntin or muntin bars are positioned in the insulating glass unit. In another and/or alternative non-limiting design, the muntin or muntin bars in a certain location include a cavity, opening and/or slot that has a special configuration. In addition, the spacer frame and/or mounting element that can be connected to the spacer frame also includes a specially configured flange that is designed to be inserted into a specially configured cavity, opening and/or slot on the muntin or muntin bars. The specially configured cavity, opening and/or slot in the muntin or muntin bars can be located in a certain region on the muntin or muntin bars; however, this is not required. Likewise, the specially configured flange on the spacer frame and/or mounting element can be located in a certain region on the insulating glass unit; however, this is not required. The combination of the specially configured flange and the specially configured cavity, opening and/or slot can be used to ensure the proper positioning and/or orientation of the muntin or muntin bars in the insulating glass unit, and/or can be used to ensure that the muntin or muntin bars are facing upward and/or downward in the proper direction when the muntin or muntin bars are positioned in the insulating glass unit.

In yet another and/or alternative non-limiting aspect of the present invention, there is provided an insulating glass unit that includes a reduced number of seals and spacer frames. Prior art insulating glass units required four (4) seals and two spacer frames for a three glass sheet system. Prior art insulating glass units required six (6) seals and three spacer frames for a four glass sheet system. The use of an increased number of spacer frames for the three and four glass sheet insulating glass units generally resulted in a substantial increase in thickness of the insulating glass unit. This increase in thickness prevented such insulating glass units from being substituted with two glass sheet insulating glass unit since such substitution or replacement required modifications to the building structure to accommodate the thicker insulating glass units. Such modifications to existing building structures could be costly and/or undesirable. In addition, when use of three and four glass sheet insulating glass units was contemplated for use in new building structures, the added costs associated with materials and designs to accommodate the thicker insulating glass units also could be undesirable. As such, three and four glass sheet insulating glass units have received resistence in penetrating the marketplace. In addition to the problems associated with the thicker three and four glass sheet insulating glass units, these insulating glass units required more seals and spacer frames than used for two glass sheet insulating glass units. The additional material cost associated with the three and four glass sheet insulating glass units and the additional labor and complexities to manufacture the three and four glass sheet insulating glass units made the three and four glass sheet insulating glass units much more expensive than the two glass sheet insulating glass units, thus consumers were less likely to purchase the three and four glass sheet insulating glass units. The additional seals used in the three and four glass sheet insulating glass units made such units more susceptible to having one or more of the seals being defective or aesthetically displeasing. As such, the rejection rate for three and four glass sheet insulating glass units was higher than two glass sheet insulating glass units, thereby further increasing the costs associated with three and four glass sheet insulating glass units. The insulating glass units of the present invention overcome these past problems. The insulating glass units of the present invention include a single spacer frame and can include no more than two seals, even though the insulating glass units include three or more sheets of glass. The assembly for the spacer frame and two outer glass sheets can be the same or similar to assembly processes used to manufacture prior art two glass sheet insulating glass units. As such, similar manufacturing machinery and manufacturing protocols that were used to assemble prior art two glass sheet insulating glass units can also be used to partially or fully assemble the insulating glass units of the present invention. In addition, since the insulating glass units of the present invention only use one spacer frame and potentially no more than two seals, the increased material costs, and/or manufacturing costs for the insulating glass unit of the present invention as compared to prior art three and four glass sheet insulating glass units can be eliminated or substantially avoided by the insulating glass units of the present invention. Still further, since the insulating glass units of the present invention only use one spacer frame and potentially no more than two seals, concerns regarding one or more of the seals being defective or aesthetically displeasing is substantially reduced or eliminated. Still even further, since the insulating glass units of the present invention only use one spacer frame and potentially no more than two seals, the thickness of the insulating glass units of the present invention can be maintained so as to have the same or similar thickness as a prior art two glass sheet insulating glass unit. As such, the insulating glass units of the present invention that includes three or four glass sheets can be readily substituted for a prior art two glass sheet insulating glass unit without having to modify or substantially modify a preexisting building structure. Yet still even further, since the insulating glass units of the present invention only use one spacer frame and potentially no more than two seals, manufacturing concerns regarding misalignment of the one or more intermediate glass sheets that are positioned between the two outer glass sheets are reduced or eliminated. When multiple spacer frames are used in prior art three and four glass sheet insulating glass units, the misalignment of all the glass sheets and the spacer frames is a concern during assembly of the three and four glass sheet insulating glass units and during the pressing and/or heating of the three and four glass sheet insulating glass units to set the seals. The misalignment or movement of the glass sheets or multiple spacer frames can result in a defective and/or undesirable product. The single spacer frame system used in the insulating glass units of the present invention significantly reduces or eliminates such problems. As such, the one or more advantages discussed above make the insulating glass units of the present invention a significant improvement over prior art three and four glass sheet insulating glass units.

In still yet another and/or alternative non-limiting aspect of the present invention, there is provided an insulating glass unit that can include different intermediate glass sheet thickness. The insulating glass unit of the present invention includes the use of a mounting element that connects and/or secures one or more intermediate glass sheets to the spacer frame prior to the two outer glass sheets being attached and/or sealed to the outer side surfaces of the spacer frame. Because most of the structural integrity of the insulating glass unit of the present invention is associated with the two outer glass sheets and the spacer frame construction, the intermediate glass sheets can be made thinner than the outer glass sheets. The use of a thinner intermediate glass sheet can result in 1) reduced weight for the insulating glass unit, 2) reduced material costs of the insulating glass unit, and/or 3) additional space between the two outer glass sheets. The additional space can be used to a) insert additional intermediate glass sheets between the two outer glass sheets, b) insert a muntin between the two outer glass sheets, c) insert additional insulating gas between the two outer glass sheets, and/or d) increase the insulating value of the insulating glass unit. As can be appreciated, there can be other or alternative advantages for the use of one or more thinner intermediate glass sheets in the insulating glass unit of the present invention.

In another and/or alternative non-limiting aspect of the present invention, there is provided an insulating glass unit that reduces the amount of edge light transmission through one or more intermediate glass sheets in the insulating glass unit. It has been found that the edge of and/or the region about the edge of the one or more intermediate glass sheets in the insulating glass unit has a tendency to transmit light through the one or more intermediate glass sheets, and thus highlight small or slight defects in the one or more intermediate glass sheets and/or the two outer glass sheets, and/or highlight dirt, smudges, fingerprints, etc. that may be located on the one or more intermediate glass sheets and/or the two outer glass sheets. As such, the problems associated with edge light transmission through one or more intermediate glass sheets can result in perceived quality problems associated with the insulating glass unit. The insulating glass unit of the present invention can be used to reduce or eliminate edge light transmission through one or more intermediate glass sheets. In one non-limiting embodiment of the present invention, the edge and/or regions about the edge of one or more intermediate glass sheets is coated with a material that reduces or eliminates edge light transmission. Non-limiting examples of such coatings include, but are not limited to, 1) paint (e.g., black paint, etc.), polymer coatings, etc.; and/or 2) an edge insert formed of a material (e.g., wood, fabric, rubber, plastic or other polymer, metal, ceramic, composite material, etc.) that has little, if any, light transmission properties which is designed to be inserted onto and/or secured to the edge of one or more intermediate glass sheets. In another and/or alternative non-limiting embodiment of the present invention, the edge and/or regions about the edge of one or more intermediate glass sheets is at least partially covered by the spacer frame and/or mounting element. The spacer frame and/or mounting element can include a cavity that is designed to receive at least a portion of the edge of one or more intermediate glass sheets and at least partially shield the edge from light. As can be appreciated other or additional arrangements on the spacer frame and/or mounting element can be used to at least partially shield the edge of one or more intermediate glass sheets from light.

In still another and/or alternative non-limiting aspect of the present invention, there is provided an insulating glass unit that has improved aesthetics for the internal structures of the insulating glass unit. In prior art insulating glass units, the channel of the frame spacer can typically be seen once the insulating glass unit is fully assembled. It is common that the channel of the spacer frame includes 1) a bead of desiccant, 2) one or more openings that were used to remove gas from and/or to insert gas into the insulating glass unit, and/or 3) one or more plugs that were used to seal or cover the openings in the channel of the spacer frame. As such, the channel of the spacer frame can include one or more unsightly and/or undesirable elements that can make the insulating glass unit less aesthetically pleasing. The insulating glass unit of the present invention can be used to overcome this disadvantage of prior art insulating glass units. In one non-limiting embodiment of the present invention, the insulating glass unit includes a mounting element that can be inserted at least partially into the channel of the spacer frame and/or be used to at least partially cover the channel in the spacer frame. The use of the mounting element can thus be used to cover and/or hide the one or more unsightly or undesirable elements in the channel of the spacer frame. As such, the insulating glass unit of the present invention can have a cleaner look and/or more aesthetically pleasing look. The mounting element can be formed of a dark material (e.g., black, etc.) and/or a material that better blends with the color of the spacer frame so as to further mask or hide the spacer frame, components about the spacer frame, reduce edge light transmission problems, etc.; however, this is not required.

In yet another and/or alternative non-limiting aspect of the present invention, there is provided an insulating glass unit that includes one or more intermediate glass sheets that are asymmetrically oriented to the outer glass sheets. The asymmetric orientation of one or more intermediate glass sheets in the insulating glass unit of the present invention can have several advantages, namely 1) reduce the amount of sound transmission through the insulating glass unit, and/or 2) increase the thickness of at least one cavity that is positioned between the outer glass sheets. The reduction in sound transmission is believed to be due in part to the differing harmonics the sound has as it passes through different cavity thicknesses. The differing harmonics are believed to act as a filter which results in the reduction of sound through the insulating glass unit. As can be appreciated, there may be other or additional reasons for the reduction of sound through the insulating glass unit. The increased thickness of at least one cavity of the insulating glass unit can be used to alter the insulating value of the insulating glass unit and/or to enable a greater variety of muntins to be used in the insulating glass unit; however, this is not required. As can be appreciated, the increased cavity thickness can have other or additional advantages. The insulating value of the insulating glass unit can be altered by inserting one or more different insulating gasses in different cavities. As can also or alternatively be appreciated, one or more cavities can be designed to include an insulating gas and one or more other cavities can be absent an insulating gas. By selecting the type and/or amount of insulating gas in one or more cavities in combination with the volume of the cavities, the insulating value of the insulating glass unit can be better customized as compared to prior art insulating glass units. As can also or alternatively be appreciated, one or more components of the insulating glass unit (e.g., spacer frame, mounting element, etc.) can include one or more channels, slots, openings, etc. that can be used to control and/or select which cavity gas is to be inserted into and/or removed from; however, this is not required. The increased thickness of at least one cavity of the insulating glass unit can also or alternatively be used to accommodate a muntin that is positioned in one or both cavities. The asymmetrical orientation of one or more intermediate glass sheets can be used to increase the thickness of the cavity to accommodate a muntin having a certain thickness that could not otherwise be inserted in one or more cavities that had the same size.

In still yet another and/or alternative non-limiting aspect of the present invention, there is provided an insulating glass unit that includes an intermediate glass sheet mounting arrangement that enables one or more intermediate glass sheets to be connected to and/or secured to a spacer frame while the spacer frame is in its final or substantially final form. In some prior art insulating glass units, the spacer frame had to be fitted about one or more of the intermediate glass sheets before further assembly of the insulating glass unit could proceed. This process of fitting the spacer frame about the one or more of the intermediate glass sheets did not lend itself to being an easy process or a process that could be automated. The insulating glass unit of the present invention includes a spacer frame and/or mounting element arrangement that enables the one or more intermediate glass sheets to be connected to and/or secured to a spacer frame while the spacer frame is in its final or substantially final form. As such, the novel spacer frame and/or mounting element arrangement provides a simpler arrangement to secure one or more intermediate sheets of glass to the spacer frame so as to reduce time and/or costs associated with the manufacture of the insulating glass unit, and/or provides a simpler arrangement to secure one or more intermediate sheets of glass to the spacer frame to enable the one or more intermediate sheets of glass to be assembled by an automated or semi-automated process. As can be appreciated, many different configurations for the spacer frame and/or mounting element can be used to achieve the objects set forth above. In one non-limiting embodiment of the invention, the spacer frame includes one or more connection flanges and/or other types of connection arrangements (e.g., opening, slot, rib, etc.) in the channel and/or at the top lip of the channel that can be used to engage with one or more portions of the mounting element. The mounting element is designed to be substantially connected to or secured to one or more intermediate glass sheets prior to the mounting member being connected to and/or secured to the spacer frame; however, this is not required. The mounting member also can include one or more connection flanges and/or other types of connection arrangements (e.g., opening, slot, rib, etc.) that can be used to engage with one or more portions of the spacer frame.

In another and/or alternative non-limiting aspect of the present invention, the insulating glass unit of the present invention can be at least partially formed by use of an automated or semi-automated process. Use of an automated or semi-automated process to form or at least partially form the insulating glass units and/or one or more components of the insulating glass units can be advantageous for one or more reasons. For example, the use of an automated or semi-automated process to form or at least partially form the insulating glass units can result in 1) increased production rates for the insulating glass units, 2) more uniform production of multiple insulating glass units, 3) standardization of quality for the insulating glass units, 4) reduction in cost to manufacture the insulating glass units, 5) reduction in damage to the insulating glass units due to a reduction in human contact with one or more components of the insulating glass units, and/or 6) reduction in the incidence of rejecting insulating glass units due to a reduction in human contact with one or more components of the insulating glass units, etc. As can be appreciated, many different types of automated or semi-automated systems can be used to form one or more components of the insulating glass unit. Non-limiting examples of automated or semi-automated systems that can be used in the present invention to partially or fully form the insulated glass unit of the present invention are disclosed in U.S. Pat. Nos. 5,928,673; 6,068,720; 6,926,782; 6,954,676; and 7,167,767; and United States Patent Publication Nos. 2003/0233163; 2006/0075869; and 2007/0112451, all of which are incorporated herein by reference.

One non-limiting object of the present invention is the provision of an improved insulating glass unit and method for making the same.

Another and/or alternative non-limiting object of the present invention is the provision of an improved insulating glass unit that is easy to manufacture.

Still another and/or alternative non-limiting object of the present invention is the provision of an improved insulating glass unit that reduces the amount of materials and/or costs associated with the manufacture of the insulating glass unit.

Yet another and/or alternative non-limiting object of the present invention is the provision of an improved insulating glass unit and method for making the same that has a reduced number of seals.

Still yet another and/or alternative non-limiting object of the present invention is the provision of an improved insulating glass unit and method for making the same that has improved durability and/or improved quality.

Another and/or alternative non-limiting object of the present invention is the provision of an improved insulating glass unit and method for making the same that has an improved sealing arrangement.

Still another and/or alternative non-limiting object of the present invention is the provision of an improved insulating glass unit and method for making the same that has a reduced incidence of improper sealing of one or more of the intermediate glass sheets of the insulating glass unit.

Yet another and/or alternative non-limiting object of the present invention is the provision of an improved insulating glass unit and method for making the same that has asymmetrical airspaces between two or more sheets of glass.

Still yet another and/or alternative non-limiting object of the present invention is the provision of an improved insulating glass and method for making the same that reduces the amount of sound transmission through the insulating glass unit.

Another and/or alternative non-limiting object of the present invention is the provision of an improved insulating glass unit and method for making the same that has a reduced total thickness.

Still another and/or alternative non-limiting object of the present invention is the provision of an improved insulating glass unit and method for making the same that can accommodate an increased number of thickness and/or shapes of muntin without having to increase the thickness of the insulating glass unit.

Still another and/or alternative non-limiting object of the present invention is the provision of an improved insulating glass unit and method for making the same that has a mechanism and/or arrangement to reduce or eliminate errors resulting from improper insertion of a muntin in the insulating glass unit.

Yet another and/or alternative non-limiting object of the present invention is the provision of an improved insulating glass unit and method for making the same that improves the aesthetics of the insulating glass unit.

Still yet another and/or alternative non-limiting object of the present invention is the provision of an improved insulating glass unit and method for making the same that reduces the amount of the edge light transmission into one or more of the intermediate sheets of glass of the insulting glass unit.

Another and/or alternative non-limiting object of the present invention is the provision of an improved insulating glass unit and method for making the same that reduces the weight of the insulating glass unit.

Still another and/or alternative non-limiting object of the present invention is the provision of an improved insulating glass unit and method for making the same that can use different glass sheet thicknesses for one or more of the intermediate sheets in the insulating glass unit.

Yet another and/or alternative non-limiting object of the present invention is the provision of an improved insulating glass unit and method for making the same that includes a simplified mechanism and/or arrangement to secure one or more intermediate sheets of glass to the spacer frame so as to reduce time and/or costs associated with the manufacture of the insulating glass unit.

Still yet another and/or alternative non-limiting object of the present invention is the provision of an improved insulating glass unit and method for making the same that includes a simplified mechanism and/or arrangement to secure one or more intermediate sheets of glass to the spacer frame to enable the insulating glass unit to be assembled by an automated or semi-automated assembly line.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 is a partial isometric view of a prior art insulating glass unit that includes two sheets of glass;

FIG. 2 is a partial isometric view of a prior art insulating glass unit that includes three sheets of glass;

FIG. 3 is a partial isometric view of an insulating glass unit that includes three sheets of glass in accordance with the present invention;

FIG. 4 is an exploded view of the insulating glass unit of FIG. 3;

FIG. 5 is a modification of the insulating glass unit of FIG. 3 that illustrates the intermediate glass sheet asymmetrically oriented between the two outer glass sheets;

FIG. 6 is a partial isometric view of another insulating glass unit that includes three sheets of glass in accordance with the present invention that includes a novel mounting element for the intermediate glass sheet;

FIG. 7 is an exploded view of the insulating glass unit of FIG. 6;

FIG. 8 is a partial isometric view of another insulating glass unit that includes three sheets of glass in accordance with the present invention that includes a novel mounting element for the intermediate glass sheet;

FIG. 9 is an exploded view of the insulating glass unit of FIG. 7;

FIG. 10 is a front elevation view of a prior art insulating glass unit that includes three sheets of glass and a muntin;

FIG. 11 is a front elevation view of another insulating glass unit that includes three sheets of glass in accordance with the present invention that includes a novel mounting element for the intermediate glass sheet and a muntin; and,

FIG. 12 is an exploded view of the insulating glass unit of FIG. 11.

### DETAILED DESCRIPTION OF THE PREFERRED EMBODIMENTS

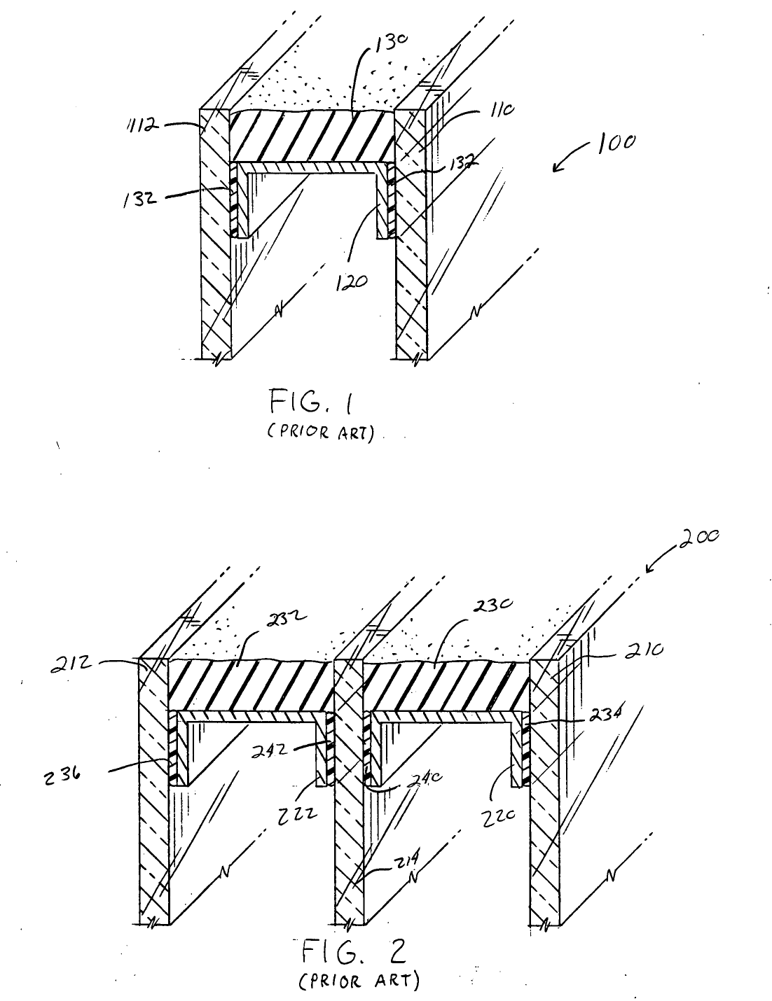

Referring now to the drawings wherein the showings are for the purpose of illustrating preferred embodiments of the invention only and not for the purpose of limiting same, FIG. 1 illustrates a prior art insulating glass unit (IGU) 100. The IGU 100 includes a pair of outer glass sheets 110 and 112 that are secured to a spacer frame 120 by one or more layers 130, 132 of an adhesive or moisture impervious adhesive and/or sealant. The one or more layers of adhesive and/or sealant may be the same or a different type of adhesive and/or sealant, and/or a single layer of adhesive and/or sealant can be used to form the seals between the outer glass sheets and the spacer frame. An insulating gas can be inserted between and sealed between the outer glass sheets to improve the thermal properties of the IGU. Non-limiting examples of this prior art arrangement for an IGU are disclosed and discussed in U.S. Pat. Nos. 5,617,699; 5,675,944; and 5,813,191, all of which are incorporated herein by reference.

A three glass sheet arrangement is illustrated in FIG. 2. In this prior art arrangement, two IGU units as illustrated in FIG. 1 are secured together to form a three glass sheet system. The three glass sheet IGU 200 includes a pair of outer glass sheets 210, 212 that are secured to two spacer frames 220, 222, respectively by one or more layers of adhesive and/or sealant 230, 232, 234, 236. The one or more layers of adhesive and/or sealant may be the same or a different type of adhesive and/or sealant, and/or a single layer of adhesive and/or sealant can be used to form the seals between the outer glass sheets and the two spacer frames. An intermediate glass sheet 214 is positioned symmetrically between outer glass sheets 210, 212 and is secured to both spacer frames 220, 222 by an adhesive and/or sealant 240, 242. The adhesive and/or sealant layers 240, 242 can be the same type of adhesive and/or sealant used for adhesive and/or sealant layers 230, 232, 234, 236. An insulating gas can be inserted between and sealed between intermediate glass sheet 214 and one or both of the outer glass sheets to improve the thermal properties of the IGU.

As shown in FIG. 2, the addition of glass sheet 214 results in a substantial increase in the thickness of the IGU. As such, IGU 200 cannot typically be used in window frames designed for IGU thickness associated with only two glass sheet systems. In addition, an additional spacer frame and sealant layers are required for IGU 200. This added material can substantially increase the cost of the three glass sheet IGU, thereby making it economically infeasible or less desirable to use in many applications. As mentioned above, the added thickness associated with three glass sheet IGUs can also result in increased window frame costs and/or installation costs; thereby also making such IGUs economically infeasible or undesirable to use in many applications. The additional thickness associated with IGU does not allow IGU 200 to replace an existing two glass sheet IGU as illustrated in FIG. 1 without having to first modify a building structure. Such modifications to a building structure can be costly and/or undesirable. The added seals required by IGU 200 as compared to IGU 100 can result in more errors in assembly and/or defects in the final IGU 200. Due to the added costs and complexities associated with three glass sheet IGUs, there has been limited adoption of such IGUs for use in many types of commercial and non-commercial structures.

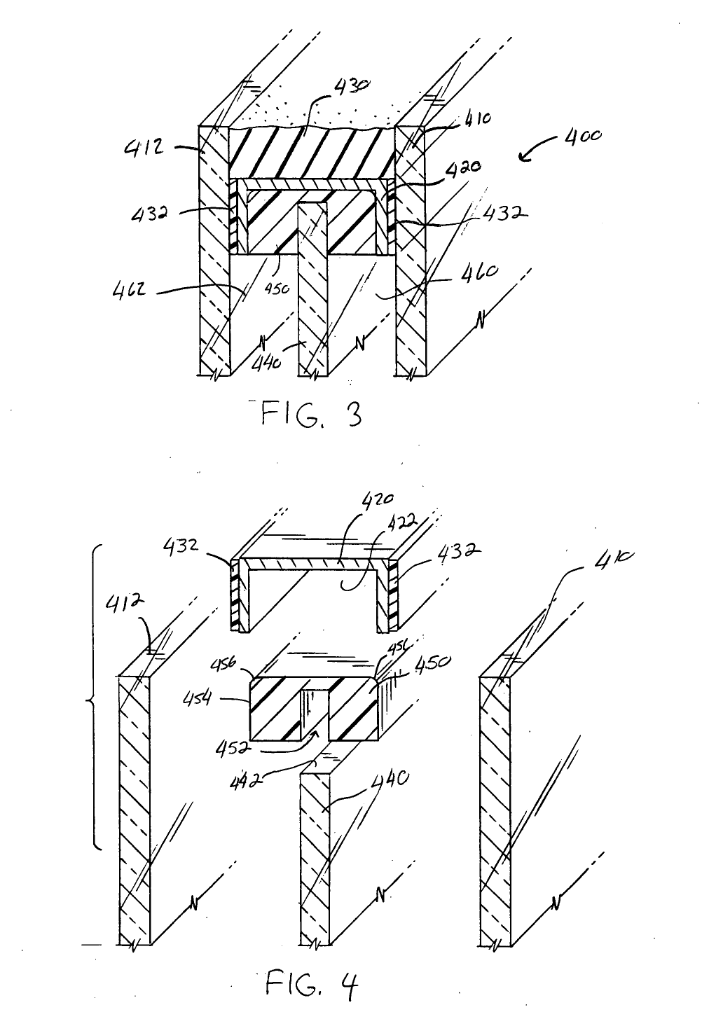

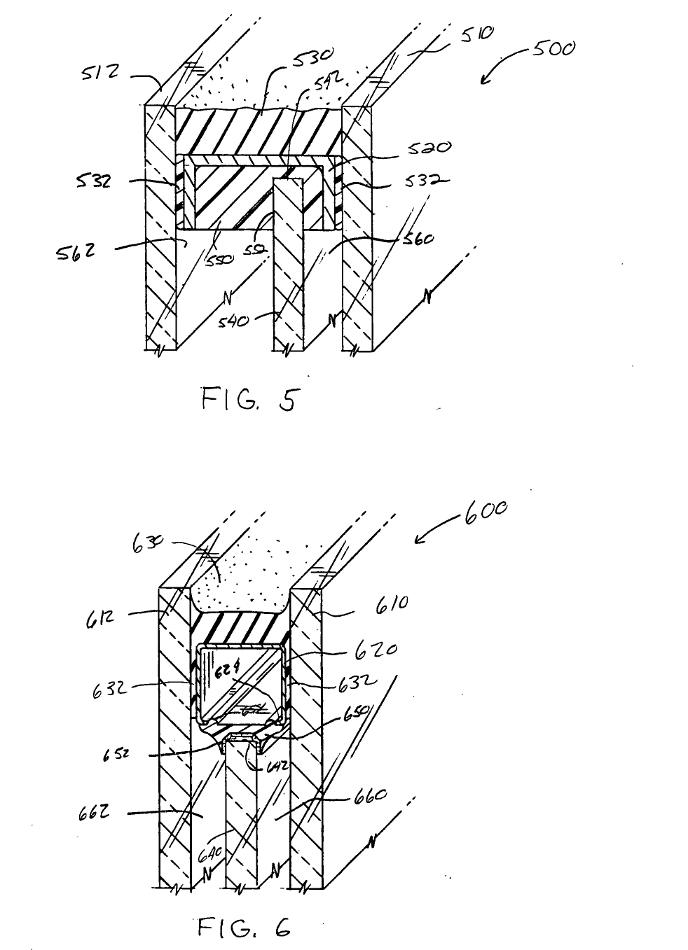

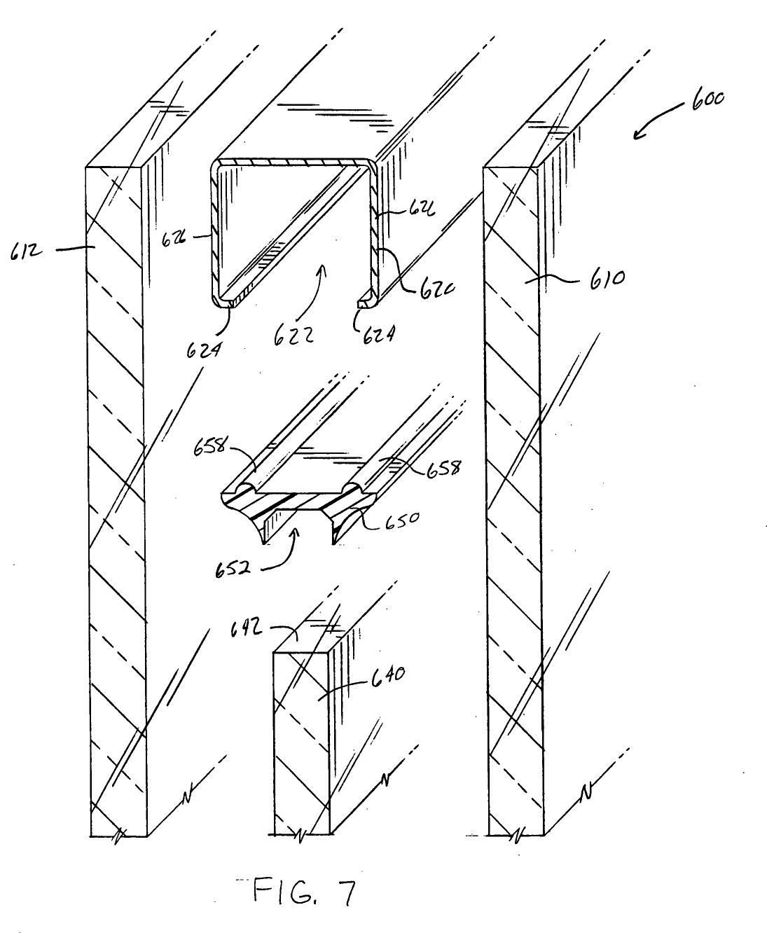

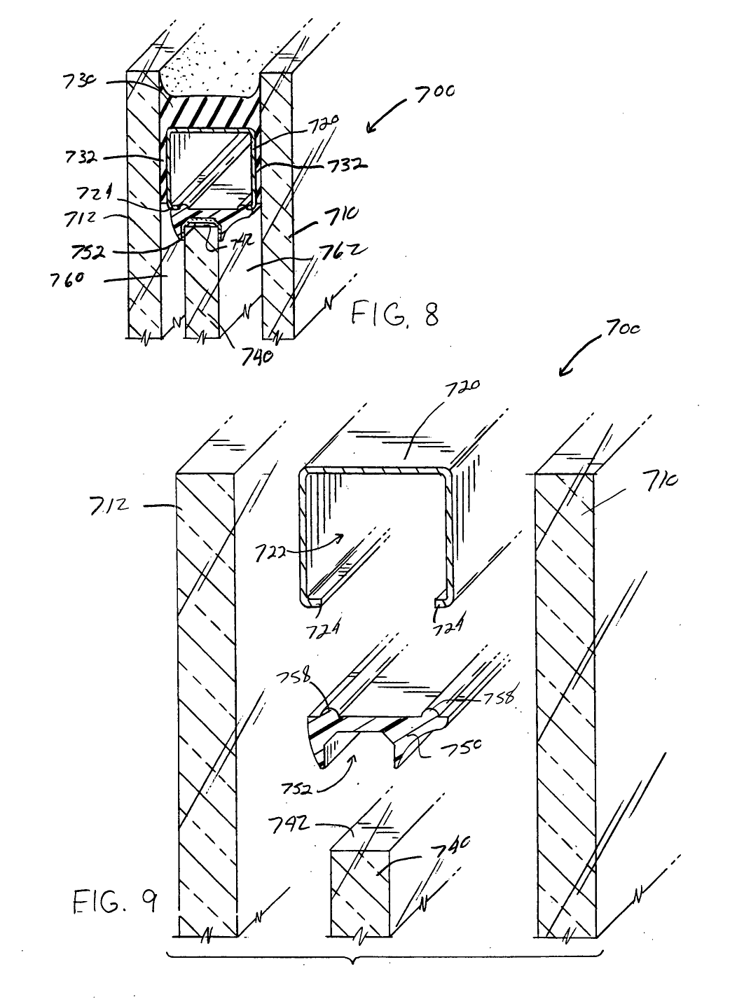

Referring now to FIGS. 3 and 4, an improved IGU 400 in accordance with the present invention is illustrated. The IGU 400 includes a pair of outer glass sheets 410 and 412 that are secured to a spacer frame 420 by one or more layers 430,432 of an adhesive or moisture impervious adhesive sealant. The outer glass sheets can be formed of the same material and/or have the same thickness; however, this is not required. The one or more layers of adhesive or moisture impervious adhesive sealant may be the same or a different type of adhesive or moisture impervious adhesive sealant, and/or a single layer of adhesive or moisture impervious adhesive sealant can be used to form the seals between the outer glass sheet and the spacer frame. In one non-limiting arrangement, a silicon and/or acrylic sealant is used for layer 432 to secure the outer glass sheets to the spacer frame 420. Layer 432 can be a pressure contact adhesive or moisture impervious adhesive sealant and/or require heat and pressure to form the seal. Furthermore, a hot melt butyl sealant, that may or may not contain a desiccant, can be used for layer 430; however, this is not required. As described so far above, the arrangement of IGU 400 is similar to IGU 100. IGU 400 will be described as having a low thermal conducting edge; however, it will be appreciated that IGU 400 is not limited to an IGU that is thermally insulating and/or has a low thermal conductivity edge. The adhesive or moisture impervious adhesive sealant layers 432 are generally formed to be thin and wide so as to reduce the diffusion of gases into or out of the IGU; however, this is not required. In one non-limiting arrangement, the adhesive or moisture impervious adhesive sealant layer has an average thickness of about 0.002-0.375 inches, typically about 0.004-0.1 inches, and more typically about 0.005-0.05 inches; however, other thickness can be used. The average width of the adhesive or moisture impervious adhesive sealant layer is about 0.08-1 inches, typically about 0.1-0.75 inches, and more typically about 0.2-0.6 inches; however, other average widths can be used. As illustrated in FIG. 3, adhesive or moisture impervious adhesive sealant layer 430 is applied at least partially in a channel formed by the top surface of the spacer frame and the edges of outer glass sheets extending beyond the edge of the spacer frame. In one non-limiting arrangement, the average thickness of adhesive or moisture impervious adhesive sealant layer 430 is about 0.010-1.50 inches, typically about 0.05-1 inches, more typically about 0.1-0.5 inches, and even more typically about 0.04-0.25 inches; however, other average thickness can be used.

IGU 400 can have three or more sheets of glass. IGU 400 will be described with particular reference to an IGU having three sheets of glass; however, it will be appreciated that the IGUs in accordance with the present invention can have two or more intermediate glass sheets. The IGU 400 will be described with particular reference to an IGU having outer sheets and an intermediate sheet formed of glass; however, it can be appreciated that one or more sheets of glass can be formed of another transparent or semi-transparent material. The one or more sheets of glass in IGU 400 can be coated with one or more coatings and/or be a colored glass and/or a non-clear glass so as to alter the aesthetic attributes of the IGU, reduce sun glare, reduce heat loss through the IGU, etc.; however, this is not required.

Referring again to FIGS. 3 and 4, an inner or intermediate glass sheet 440 is secured in position between outer glass sheets 410, 412 to form glass cavities 460, 462 between the three glass sheets. Intermediate glass sheet 440 can have the same or different thickness as outer glass sheets 410, 412. Intermediate glass sheet 440 can be formed of the same or different material as outer glass sheets 410, 412. Generally, intermediate glass sheet 440 is formed of the same material as outer glass sheets 410, 412 and has a thickness that is equal to or less than the thickness of one or both of outer glass sheets 410, 412.

The side edge 442 of the intermediate glass sheet 440 is secure to spacer frame 420. A mounting element 450 is designed to engage one or more regions of the side edge of intermediate glass sheet 440. The mounting element includes a channel or slot 452 that enables edge 442 of the intermediate glass sheet 440 to fit therein. Slot 452 is illustrated as a generally U-shaped slot; however, it can be appreciated that many other shaped slots can be used (e.g., V-Shaped, C-shaped, etc.). The size of slot 452 can be selected to create a friction fit between the edge 442 of the intermediate glass sheet 440 and the mounting element 450; however, this is not required. As can be appreciated, an adhesive or moisture impervious adhesive sealant can also or alternatively be used to secure the edge 442 of the intermediate glass sheet 440 in slot 452 of the mounting element. The mounting element is generally designed to engage a majority of edge 442; however, it can be appreciated that less than a majority of edge 442 is engaged with mounting element 450. In practice, the mounting element is generally designed to engage at least about 70 percent of edge 442, more typically at least about 80 percent of edge 442, and even more typically at least about 90 percent of edge 442. In some arrangements in accordance with the present invention, the mounting element engages 100 percent of edge 442 of the intermediate glass sheet 440. In some other arrangements in accordance with the present invention, no more than about 90-99 percent of edge 442 engages with mounting element 450. As will be explained in more detail below, the mounting element can be designed so that 1) the intermediate glass sheet and mounting element can be easily secured to the spacer frame during assembly, 1) the intermediate glass sheet and mounting element can be easily secured to the spacer frame during assembly while the spacer frame is fully or substantially fully formed into its final shape, 3) one or both inner cavities 460, 462 of the IGU can be more easily evacuated or purged of gas, and/or 4) one or both inner cavities 460, 462 can be filled with an insulating gas (e.g., argon, krypton, etc.).

The mounting element 450 can be formed of a variety of materials. Generally the material used to form mounting element 450 is an insulating material so as to limit the transmission of heat between spacer frame 420 and intermediate glass sheet 440 and between other elements of the finished insulating glass unit including, but not limited to, 412, 410, and 432; however, this is not required. In one non-limiting arrangement, mounting element 450 is formed of a rubber or polymer material that has been molded or extruded; however, this is not required. The material used to form the mounting element can be a hard or soft material. Generally the material used to form the mounting element has a hardness and rigidity to 1) substantially maintain the intermediate glass sheet in a spaced relationship between the outer glass sheets and/or 2) maintain a generally constant spacing between the intermediate glass sheet and the outer glass sheets. The material used to form the mounting element can be a curable material and/or a material that changes in physical properties (e.g., hardness, rigidity, color, etc.) when exposed to heat, electromagnetic waves (e.g., visible light, IR, UV, etc.) and/or radiation; and/or exposed to one or more gasses (e.g., air, argon, krypton, nitrogen, etc.) in and/or inserted into cavities 460, 462; however, this is not required.

The mounting element 450 can include a coating of and/or include a desiccant; however, this is not required. As such, one or more desiccants can be incorporated in the material used to form the mounting element and/or be coated on one or more portions of the mounting element to facilitate in moisture control in cavity 460 and/or cavity 462. When a coating of desiccant is applied to the mounting element, such coating is generally applied prior to the connection of the mounting element to the intermediate glass sheet; however, this is not required. The coating of desiccant can be secure to the mounting element by use of an adhesive or moisture impervious adhesive sealant; however, this is not required. If an adhesive or moisture impervious adhesive sealant is used, the adhesive or moisture impervious adhesive sealant can incorporate and/or encapsulate one or more desiccants, and/or be used to bond one or more desiccants to the mounting element. Furthermore, if an adhesive or moisture impervious adhesive sealant is used, such adhesive or moisture impervious adhesive sealant can also facilitate securing the edge of the intermediate glass sheet to the mounting element; however, this is not required.

The mounting element can be designed to secure the edge 442 of intermediate glass sheet 440 in a manner that improves the aesthetics of the IGU. The use of the mounting element can be used to 1) ensure proper orientation of the intermediate glass sheet between the outer glass sheets, 2) reduce the amount of human contact on the intermediate glass sheet, thereby reducing the introduction of dirt, fingerprints, etc. to the intermediate glass sheet during assembly of IGU 400, 3) improve the aesthetics of IGU 400 by reducing or eliminating issues regarding swedge corners, matrix balls, lumps, etc., 4) reduce or eliminate the undesired appearance of the channel in the spacer frame, thus producing a cleaner look for the inside components of the IGU, 5) reduce or eliminate unsightly screws, holes, etc. (e.g., gas filing holes, gas hole plugs, etc.) in and/or formed in the channel of the spacer frame, and/or 6) reduce or eliminate edge light transmission by the intermediate glass sheet, and/or reduce the amount of internal reflections created by the intermediate glass sheet, both of which can increase the perception of defects in the IGU. As can be appreciated, the use of the mounting element can result in other or additional advantages for IGU 400. The reduction or elimination of edge light transmission by the intermediate glass sheet, and/or the reduction of the amount of internal reflections created by the intermediate glass sheet can be accomplished in part by the mounting element having and/or be at least partially formed of a low light transmitting material (e.g., black material, etc.) at least about the edge of the intermediate glass unit. In addition and/or alternatively, a sufficient amount of the edge of the intermediate glass sheet can be covered by the mounting element so as to reduce edge light transmission. In addition and/or alternatively, a coating (e.g., black coating, etc.) can be applied to the edge and/or about the edge of the intermediate glass unit to reduce edge light transmission.

During the manufacture of IGU 400, mounting element 450 is at least partially secured to edge 442 of intermediate glass sheet 440 prior to the mounting element being connected to spacer bar 420; however, this is not required. Indeed, mounting element can be at least partially secured to spacer bar 420 prior to the spacer bar being fitted about the edge of intermediate glass frame 440. As can be appreciated, combinations of the above manufacturing sequence can also be used.

The mounting element 450 has an outside surface 454 profile that is designed to at least partially fit within channel 422 of spacer frame 420. Spacer frame 420 is illustrated as having a generally U-shaped channel 422; however, it will be appreciated that other channel shapes can be used. The outside surface 454 of mounting element 450 has a curve or tapered section 456 that can be used to facilitate in the insertion of the mounting element into channel 422 of the spacer frame; however, it will be appreciated that the use of a curved or tapered section is not required. As illustrated in FIG. 3, the size and profile of the mounting element is generally selected to substantially fill channel 422; however, this is not required. The outside surface of the mounting element is generally secured in channel 422 by use of a friction fit and/or by use an adhesive or moisture impervious adhesive sealant; however, this is not required.

As illustrated in FIG. 3, intermediate glass sheet is shown to be generally symmetrically oriented between outer glass sheets 410, 412. The configuration and size of IGU 400 is an improvement over IGU 200 illustrated in FIG. 2. IGU 400 has a thinner thickness than IGU 200. Indeed, IGU 400 can have the generally the same thickness of a traditional two sheet IGU as illustrated in FIG. 1, thus the three glass sheet IGU of FIG. 3 can be replaced with a traditional two glass sheet IGU of FIG. 1 without having to further modify the existing building structure. In addition, fewer sealing surfaces exist in IGU 400 than in IGU 200, thus there is a reduced opportunity of a seal being defective and/or improperly applied to the glass sheets and/or spacer frame. As can be appreciated, additional cost savings associated with material costs, assembly and labor costs, and/or storage and transport costs may also be realized by IGU 400 as compared to IGU 200.

As mentioned above, cavity 460 and/or cavity 462 can be evacuated of gas and/or filled with one or more gasses to improve the insulation properties of the IGU 400. Mounting element 450 and/or spacer frame can include one or more openings, slots, and/or passageways that can be used to facilitate in the evacuation of gas and/or the filling of one or more gasses in cavity 460 and/or cavity 462; however, this is not required. When the spacer frame and mounting element include one or more openings, slots, and/or passageways; such one or more openings, slots, and/or passageways can be at least partially aligned with one another; however, this is not required.

Although not illustrated in FIGS. 3 and 4, a muntin can be inserted into cavity 460 and/or cavity 462; however, this is not required. As also not illustrated in FIGS. 3 and 4, the intermediate glass sheet and/or one or more of the outer glass sheets can include a pattern taped on and/or printed and/or etched in the surface of the one or more glass sheets; however, this is not required.

During assembly of IGU 400, it will be appreciated that once the intermediate glass sheet 440 is secured to the mounting element and then secured to the spacer frame and/or the intermediate glass sheet 440 is secured to the mounting element that is already at least partially secured to the spacer frame, the assembly of the outer glass sheets 410, 412 to spacer frame 420 can be accomplished by existing assembly methods and machinery that were traditionally used to assembly IGU 100 as illustrated in FIG. 1. As such, the costs associated with integrating an assembly system for IGU 400 can potentially be much less costly than having to create a completely new assembly process and protocols. IGU 400, as compared to IGU 200, has a 50% reduction in the number of seals, which reduction in the number of seals can result in increased durability of IGU 400, and/or reduce or eliminate concerns associated with the seal quality of the intermediate glass sheet when the IGU is at least partially formed in an intercept oven/roller press process. The reduced number of seals can also or alternatively reduce manufacturing and/or raw material costs for the IGU, and/or reduce manufacturing errors or inconsistencies associated with applying seals to the IGU. As mentioned above, the assembly of IGU 400, as compared to IGU 200, can result in a reduced number of manufacturing defects that can result from human and/or machine contact with the intermediate glass sheet. As also mentioned above, IGU 400, as compared to IGU 200, can have improved aesthetics by creating a cleaner, slicker, less bulky IGU, thereby reducing questions or concerns regarding swedge corners, matrix balls and lumps, inconsistencies in desiccant material, etc. on the IGU; however this is not required. IGU 400 can improve the aesthetics of the IGU by filling and/or covering the spacer frame channel with the mounting element; however, this is not required. The covering of the channel can create a cleaner look for the IGU and/or cover-up unsightly gas holes and/or gas hole plugs (e.g., screw, rivet, etc.) in the channel of the spacer frame; however, this is not required. IGU 400 can be designed to reduce or eliminate problems associated with edge light transmission through the intermediate glass sheet that can cause undesired internal reflections and/or can increase the perception of defects on the intermediate glass sheet and/or on other components of the IGU; however, this is not required. IGU 400 can be designed to use a thinner sheet of glass for the intermediate glass sheet, thereby reducing the cost and/or weight of the IGU; however, this is not required.

Referring now to FIG. 5, there is another embodiment for an IGU 500 in accordance with the present invention. IGU 500 has a similar configuration to and has similar advantages of IGU 400, thus such configurations and advantages will not be repeated herein or repeated herein in detail. IGU 500 includes a pair of outer glass sheets 510 and 512 that are secured to a spacer frame 520 by one or more layers 530, 532 of an adhesive or moisture impervious adhesive sealant. An inner or intermediate glass sheet 540 is secured in position between outer glass sheets 510, 512 to form glass cavities 560, 562 between the three glass sheets. A mounting element 550 engages one or more regions of the side edge of intermediate glass sheet 540. The mounting element includes a channel or slot 552 that enables edge 542 of the intermediate glass sheet 540 to fit therein. The mounting element used in IGU 500 is different from the mounting element used in IGU 400 in that slot 542 is positioned in the mounting element to cause the intermediate glass sheet to be mounted asymmetrically between outer glass sheets 510, 512.

An asymmetric orientation of the intermediate glass sheet 540 can have several advantages, namely 1) potentially reducing sound transmission through the IGU, 2) enabling the IGU to use thicker muntins in cavity 562 without having to increase the thickness of the IGU, and/or 3) enabling a muntin to be inserted into a thicker cavity so that the muntin does not contact an outer sheet and/or intermediate sheet, thereby improving the aesthetics of the IGU and/or reducing the amount of heat transmission through the IGU. As such, the asymmetric orientation of intermediate glass sheet 540 can provide one or more important and unique advantages that could not be achieved using prior art IGU configurations without having to substantially increase the width of the IGU. It is believed that by creating two different spacings between the intermediate glass sheet and the two outer glass sheets, less sound will pass through the IGU. This is believed to occur because the resonance frequency between one cavity will be different from the other cavity, thus result in a partial sound filter. The asymmetric orientation of intermediate glass sheet 540 can be used to create a thicker cavity. As illustrated in FIG. 5, cavity 562 has a greater cavity thickness than cavity 560. Various types of muntins are currently being created to satisfy the continuous growing demand for new and unique windows. New materials and/or new uses of material are also being developed that create unique looks and/or have unique and/or desirable finishes. In view of this demand, new designs of muntin and/or new materials for muntins are being proposed or used. Due to the spacing limitations imposed by prior art three glass sheet IGUs as illustrated in FIG. 3, many of the new muntin designs could not be used or were dismissed due to cavity thickness limitations. The mounting element 550 illustrated in FIG. 5 can be used to overcome this past thickness limitation. As illustrated in FIG. 5, mounting element 540 can be used to position intermediate glass sheet 540 closer to outer glass sheet 510, thereby reducing the thickness of cavity 560 and increasing the thickness of cavity 562. The increase in the cavity thickness of cavity 562 enables cavity 563 to have a thicker muntin inserted therein, thereby increasing the versatility of IGU 500. In one non-limiting arrangement of the invention, cavity 562 is at least about 5% greater in volume than cavity 560. In another non-limiting arrangement of the invention, cavity 562 is at least about 10% greater in volume than cavity 560. In still another non-limiting arrangement of the invention, cavity 562 is at least about 20% greater in volume than cavity 560. In yet another non-limiting arrangement of the invention, cavity 562 is at least about 40% greater in volume than cavity 560. In still yet another non-limiting arrangement of the invention, cavity 562 is at least about 100% greater in volume than cavity 560. In still another non-limiting arrangement of the invention, cavity 562 is at least about 150% greater in volume than cavity 560. In yet another non-limiting arrangement of the invention, cavity 562 is at least about 200% greater in volume than cavity 560.

Referring now to FIGS. 6 and 7, there is illustrated another embodiment for an IGU 600 in accordance with the present invention. IGU 600 has a similar configuration to and advantages of IGU 400, thus such configurations and advantages will not be repeated herein or repeated herein in detail. IGU 600 includes a pair of outer glass sheets 610 and 612 that are secured to a spacer frame 620 by one or more layers 630, 632 of an adhesive or moisture impervious adhesive sealant. An inner or intermediate glass sheet 640 is secured in position between outer glass sheets 610, 612 to form glass cavities 660, 662 between the three glass sheets. A mounting element 650 engages one or more regions of the side edge of intermediate glass sheet 640. The mounting element includes a channel or slot 652 that enables edge 642 of the intermediate glass sheet 640 to fit therein. The mounting element used in IGU 600 is different from the mounting element used in IGU 400 in that the mounting element is designed to connect to the top portion of channel 622 of the spacer frame 620. The spacer frame may also include one or more lips 624 and/or the mounting element may include one or more connectors 658 to facilitate in the connection of the mounting element to the spacer frame.

The spacer frame and mounting element illustrated in FIGS. 6 and 7 are designed to enable the intermediate glass sheet 640 to be clipped or snapped or other wise secured to the spacer frame. This arrangement can be used to simplify the manufacture of the IGU. When assembling prior IGUs as illustrated in FIGS. 1 and 2, the spacer frame is formed into a rectangular or square frame. The IGUs illustrated in FIGS. 3-5 in accordance with the present invention cannot be fully assembled prior to the intermediate glass sheet being secured to the spacer frame. Generally, the spacer frame is formed about the intermediate glass sheet to capture the intermediate glass sheet in the spacer frame. Although the IGUs disclosed in FIGS. 3-5 are improvements over prior art IGUs, the formation of the spacer frame and intermediate glass sheet component of the IGU can be complicated, especially when attempting to automate such a process. The configuration of the spacer frame and mounting element illustrated in FIGS. 6 and 7 is designed to overcome this problem by enabling the intermediate glass sheet to be secured to the spacer frame when the spacer frame is fully formed or substantially fully formed.

As best illustrated in FIG. 7, spacer bar 620 includes two inwardly spaced lips or flanges 624. The configuration of the lips 624 is non-limiting. The one or more lips illustrated in FIG. 7 have a generally L-shaped configuration; however, other configurations such as an E-shaped, W-shaped, T-shaped, Y-shaped, P-shaped, S-shaped, D-shaped, F-shaped, J-shaped, Z-shaped, C-shaped, V-shaped, etc. configurations can be used for one or more of the lips. The one or more lips are designed to provide a surface that enables one or more connectors 658 on the mounting element to snap and/or lock onto the spacer bar while the spacer bar is maintained in its final shape or substantially final shape.

The channel of the spacer bar can include a desiccant or an adhesive-desiccant mixture so as to control the moisture content in the one or both cavities of the IGU; however, this is not required. The under side of the mounting element and/or slot of the mounting element can include a desiccant or an adhesive-desiccant mixture so as to control the moisture content in the one or both cavities of the IGU; however, this is not required. The mounting member 650 can include one or more openings, slots and the like to facilitate in 1) the function of the desiccant located in channel 622 and/or on the mounting member, and/or 2) to enable gas to be removed from and/or inserted into one or more of the cavities via an opening in the spacer frame; however, this is not required. The mounting element 650 is generally formed of a durable material (e.g., metal, plastic, composite material, etc.) that has the required strength, rigidity and/or durability to maintain the intermediate glass sheet in connection with the spacer frame.

In one non-limiting arrangement, the spacer frame is formed of a material that enables one or both of the side walls to slightly spring backward when the mounting member is being secured to the spacer frame. The one or more of the lips on the spacer bar can have a configuration and/or one or more of the connectors 658 on the mounting member can have a configuration that facilitates in the slight springing backward of one or more of the side walls as the mounting member is secured to the spacer bar. The spacer frame and/or mounting member can also include one or more elements that result in the mounting member being more securely connected to or locked to the spacer frame when the one or more side walls spring back or attempt to spring back to their original position (e.g., a groove or slot on the connection member, etc.). As can be appreciated, many different configurations for the spacer frame and/or mounting member can be used to achieve the spring back mounting arrangement, and/or the securing/locking arrangement discussed above. As can be appreciated, the spring back movement of the one or more walls of the spacer frame can be limited by the adhesive or moisture impervious adhesive sealant used to secure the outer glass sheets to the spacer bar. For example, once the adhesive or moisture impervious adhesive sealant is set, the adhesive or moisture impervious adhesive sealant rigidifies the IGU, thereby inhibiting or preventing the one or more side walls of the spacer frame from springing back and inadvertently releasing the mounting element from or loosening the mounting element on the spacer frame.

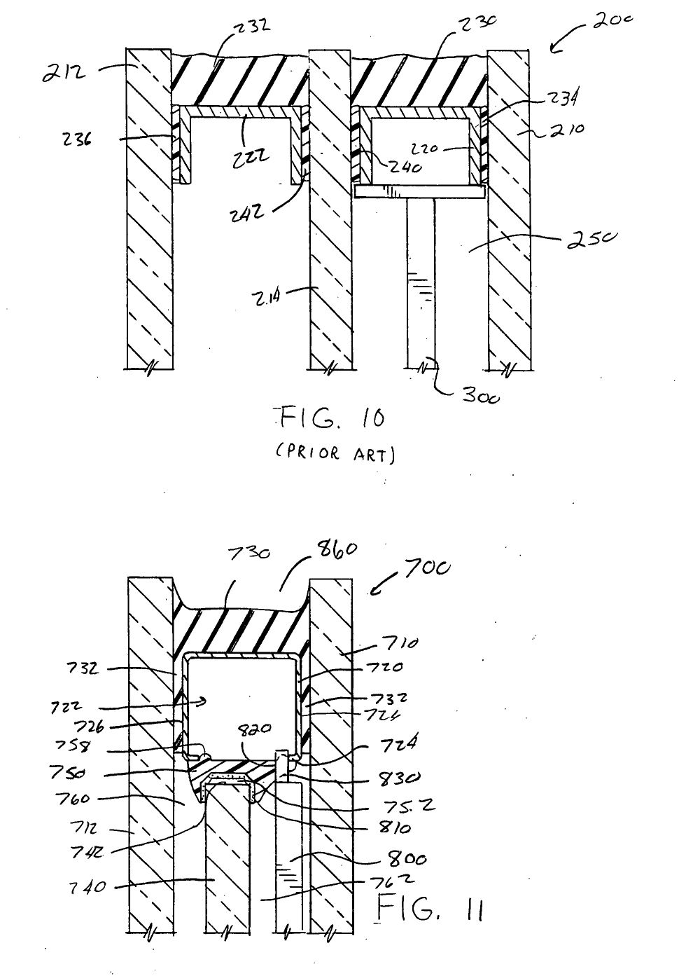

Referring now to FIGS. 8 and 9, there is illustrated another embodiment for an IGU 700 in accordance with the present invention. IGU 700 has a similar configuration to and advantages of IGU 500, thus such configurations and advantages will not be repeated herein or repeated herein in detail. IGU 700 also has a mounting element and spacer that have similar advantages and configurations of mounting element 650 and spacer bar 620 as illustrated in FIGS. 6 and 7, thus such configurations and advantages will not be repeated herein or repeated herein in detail. IGU 700 includes a pair of outer glass sheets 710 and 712 that are secured to a spacer frame 720 by one or more layers 730, 732 of an adhesive or moisture impervious adhesive sealant. An inner or intermediate glass sheet 740 is secured in position between outer glass sheets 710, 712 to form glass cavities 760, 762 between the three glass sheets. A mounting element 750 engages one or more regions of the side edge 742 of intermediate glass sheet 740. The mounting element includes a channel or slot 752 that enables edge 742 of the intermediate glass sheet 740 to fit therein. The spacer frame includes one or more lips 724 and mounting element 750 includes one or more connectors 758 to facilitate in the connection of the mounting element to the spacer frame.

The mounting element used in IGU 700 is different from the mounting element used in IGU 600 in that slot 752 is positioned on the mounting element to result in the intermediate glass sheet 740 being asymmetrically positioned between outer glass sheets 710, 712. Similar to mounting element 550 in FIG. 5, mounting element 750 positions intermediate glass sheet in a spaced relationship from the inner surfaces of outer glass sheets 710, 712 and also orients the intermediate glass sheet between the outer sheets such that cavity 762 has a larger volume that cavity 760. The advantages of the asymmetrical orientation of the intermediate glass sheet are described in detail with respect to the IGU illustrated in FIG. 5, thus will not be repeated herein.

Referring now to FIG. 10, there is illustrated a prior art IGU 200 that is the same as the IGU illustrated in FIG. 2, except that a muntin 300 is positioned in cavity 250 that is formed between outer glass sheet 210 and intermediate glass sheet 214. The muntin 300 is illustrated as being in contact with and/or connected to spacer frame 220. The construction of the muntin is well known in the art, thus will not be described in detail herein. The muntin may be mounted to the spacer bar in any convenient manner; however, this is not required. As can be appreciated, if it was desired to make IGU 200 thinner, the width of the spacer bars would have to be reduced, which in turn would result in a width reduction of cavity 250. If it was desirable to reduce the width of IGU 200 to a similar width of IGU 700, the width of spacer bars would have to be reduced such that the width of cavity 250 could not accommodate muntin 300. In addition, the customized size of the spacer bar may increase the cost of the IGU and/or require time-consuming process changes and equipment changes to accommodate the different sized spacer frames.

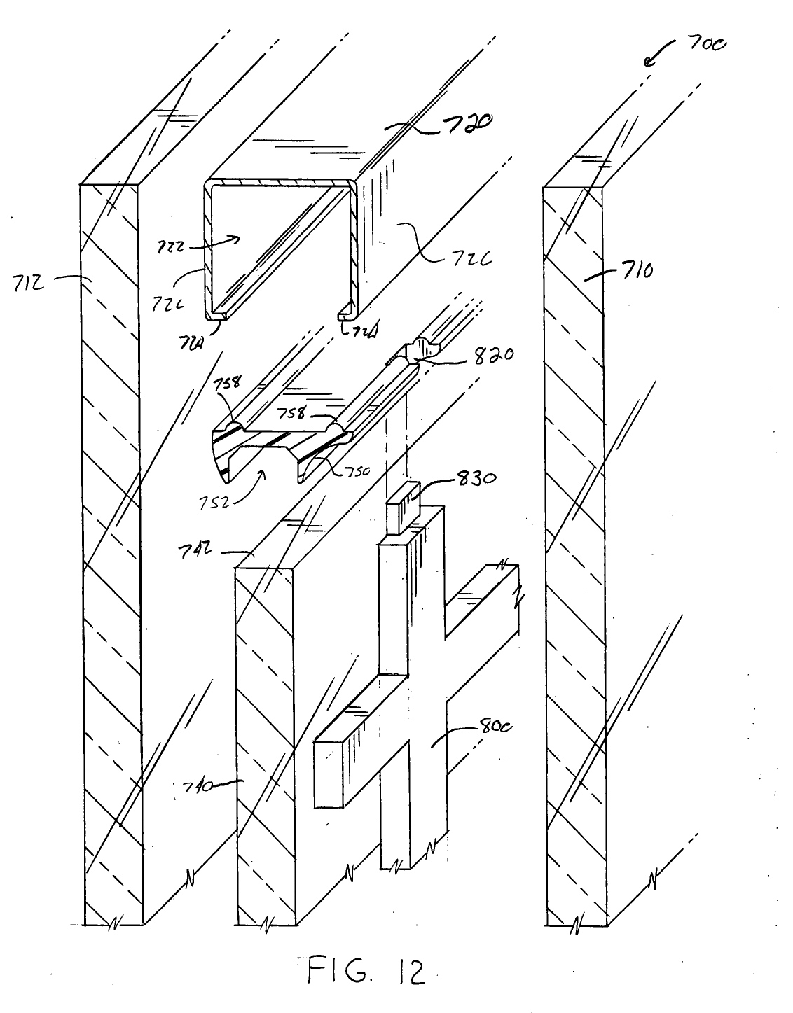

Referring now to FIGS. 11 and 12, there is illustrated IGU 700 that is a modification to the IGU illustrated in FIGS. 8 and 9. Most of the components of the IGUs illustrated in FIGS. 8-9 and 11-12 are the same, and most of the features and advantages of the two IGUs are also the same, thus such configurations and advantages will not be repeated herein or repeated herein in detail. The IGU in FIGS. 11 and 12 include a muntin 800 positioned in cavity 762. As previously discussed, mounting element 750 is designed to asymmetrically position intermediate glass sheet 740 between outer glass sheets 710, 712 such that cavity 762 has a greater width than cavity 760. The increased width of cavity 762 can thus accommodate a muntin 800 without having to increase the width of the spacer bar 720.

Mounting element 750 also illustrates two modifications that can be used, but are not required. The first modification is the use of an adhesive or moisture impervious adhesive sealant 810 in slot 752 to facilitate in securing the edge of the intermediate glass sheet 740 to the mounting element; however, this is not required. As can be appreciated, many types of adhesive or moisture impervious adhesive sealants can be used. In addition, or alternatively, substance 810 can be a cushioning or dampening material (e.g., foam, rubber, etc.) used to reduce movement or noise associated with the intermediate glass sheet due to the IGU being subject to vibrations when installed in a building or other type of structure; however, this is not required. In addition or alternatively, substance 810 can be or can include a desiccant so as to reduce moisture in one or both cavities; however, this is not required. Another modification in the mounting element is a muntin slot 820 that can be used to orient and/or connect the muntin to the mounting member. The shape of the muntin slot is non-limiting. An adhesive or moisture impervious adhesive sealant can be used to secure the muntin to the mounting member; however, this is not required.

As illustrated in FIGS. 11 and 12, muntin 800 can include a mount member 830 that can be designed to fit in and/or engage muntin slot 820; however, this is not required. The use of the muntin slot 820 and mount member 830 can be used to facilitate in securing the muntin to the mounting element; however, this is not required. The use of the muntin slot 820 and mount member 830 can be used to facilitate in the proper orientation and mounting of muntin 800 in cavity 762; however, this is not required. The shape of muntin slot 820 and/or mount member 830 can be selected to both ensure the proper orientation and mounting of muntin 800 in cavity 762, but to also ensure that the proper side of the muntin is facing the correct direction in cavity 762; however, this is not required. Several types of muntin have different colors and/or patterns on each side of the muntin. As such, the muntin must be properly positioned in cavity 762 to ensure that the desired side of the muntin is facing the proper way. The use of a certain shaped muntin slot 820 and/or mount member 830 can be used as an orientation key so that the mount member 830 only fits into muntin slot 820 when the muntin is properly oriented in cavity 762 and is also facing in the proper direction in cavity 762; however, this is not required.

A non-limiting manufacturing method for forming IGU 700 as illustrated in FIGS. 11 and 12 is described below. As can be appreciated one or more of the process steps set forth below can be part of a semi-automated or automated process. As can also be appreciated, the order of one or more of the process steps discussed below are non-limiting.

Spacer frame 720 is formed from a flat metal strip. The width and length of the metal strip is non-limiting. In one non-limiting arrangement, the metal strip has a length of about 100-150 inches, a width of about 1-2 inches and thickness of about 0.05-0.2 inches. The metal strip is subject to die cutting to create one or more holes, slots, notches, etc. along the length of the metal strip. One or more of these modifications to the metal strip enables the strip to be bent into a square or rectangular frame that has three continuous corners. The metal strip can be processed through one or more sets of forming rollers to form channel 722 and lips 724. A desiccant, when applied to the spacer frame, can be applied prior to, during and/or after the metal strip is passed through one or more forming rollers. When a desiccant is applied to the spacer frame, the desiccant is generally located in channel 722.

After spacer frame 720 is formed, an adhesive or moisture impervious adhesive sealant layer 732 can be applied to one or both outer surfaces of walls 726 prior to, during and/or after mounting member 750 is connected to spacer bar 750.

The outer glass sheets and intermediate glass sheets are generally formed from larger glass sheets that have been previously washed, dried, cut to size, tempered if required, coated if required, and inspected for quality and cleanliness prior to the glass sheets being secured to the spacer frame.

The intermediate glass sheet 740 is secured in slot 752 of mounting member 750 by use of a friction fit, adhesive or moisture impervious adhesive sealant and/or some type of mechanical connector. The color of mounting member 750 and/or the depth of slot 752 are selected to reduce or eliminate edge light transmission problems associated with the intermediate glass sheet. Generally, at least 90-99 percent of the edge of intermediate glass sheet 740 is secured to mounting member 750. Generally, intermediate glass sheet 740 is secured to the mounting member prior to the mounting member being secured to spacer frame 720.

The spacer frame and/or the mounting member can be designed such that the intermediate glass sheet can be snapped onto or otherwise secured to the spacer frame after the spacer frame has been fully or substantially fully formed into its final square or rectangular shape. Such an arrangement lends itself to an automated or semi-automated process of securing the intermediate glass sheet to the spacer frame, thereby reducing human contact and/or intervention in such a process.

A muntin, if used, can be secured to the spacer frame prior to, during, and/or after the intermediate glass sheet is secured to the spacer frame.

If one or both adhesive or moisture impervious adhesive sealant layers 732 have not been applied to the outer surface of the side walls of the spacer frame prior to or during the connection of the mounting element and intermediate glass sheet to the spacer frame, then such one or both adhesive or moisture impervious adhesive sealant layers are applied prior to outer glass sheets 710, 712 are positioned and laid on the spacer frame. The outer glass sheets and spacer frame can be moved though one or more pressure roller and/or subjected to heat to ensure a proper seal is formed between the outer glass sheets and the spacer frame.

If an insulating gas is to be inserted into one or both of cavities 760, 762, pre-exiting holes in the spacer frame can be used and/or one or more openings in the spacer frame can be formed to remove and/or insert one or more gasses into the one or both cavities. The existing or formed holes are generally closed by use of a sealant and/or mechanical device (e.g., rivet, screw, etc.); however, this is not required.

Adhesive or moisture impervious adhesive sealant layer 730 is then applied at least partially in the channel 860 about the complete perimeter of the IGU to complete the sealing of the IGU and/or provide additional structural integrity to the IGU.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

We claim:

1. An insulating unit comprising a pair of outer sheets secured to a spacer frame, an intermediate sheet positioned between and spaced from said pair of outer sheets and a mounting element at least partially secured to said spacer frame, said mounting element at least partially interconnecting said intermediate sheet to said spacer frame, said spacer frame including a base and two side walls that extend upwardly from the base to form a channel therebetween, said mounting element designed to be at least partially positioned in said channel, connected to a top portion of said channel, or combinations thereof, said each of said side walls including a mounting element connector, said mounting element including two wall connectors wherein one wall connector is designed to engage the mounting element connector on one side wall and the other wall connector is designed to engage the mounting element connector on the other side wall, said mounting element is designed to be secured to said spacer frame after said mounting element said been secured to said intermediate sheet and after said spacer frame has been substantially formed into its final square or rectangular form.

2. The insulating unit as defined in claim 1, wherein said mounting element fully interconnecting said intermediate sheet is connected to said spacer frame.

3. The insulating unit as defined in claim 1, wherein at least one side wall of said spacer frame is designed to spring back from an original position and then spring at least partially forward toward the original position as said mounting element is secured to said spacer frame.

4. The insulating unit as defined in claim 1, wherein at least one of said pair of outer sheets, said intermediate sheet, or combinations thereof is a glass sheet.

5. The insulating unit as defined in claim 1, wherein said intermediate sheet is thinner than at least one of said pair of outer sheets.

6. The insulating unit as defined in claim 1, including a muntin positioned between said pair of outer sheets.

7. The insulating unit as defined in claim 1, wherein said intermediate sheet is asymmetrically oriented between said pair of outer sheets.

8. The insulating unit as defined in claim 6, wherein said intermediate sheet is asymmetrically oriented between said pair of outer sheets

9. The insulating unit as defined in claim 8, wherein said muntin is positioned in a cavity positioned between said pair of outer sheets having a volume that is greater than a volume of at least one other cavity that is positioned between said pair of outer sheets.

10. The insulating unit as defined in claim 6, wherein said muntin includes an orientation arrangement that is designed to orient with another arrangement in said insulating unit so as to ensure the proper positioning of said muntin between said pair of outer sheets, the proper physical orientation of said muntin between aid pair of outer sheets, the proper side orientation of said muntin between said pair of outer sheets, or combinations thereof.

11. The insulating unit as defined in claim 10, wherein said mounting element, said spacer frame or combinations thereof includes a muntin orientation arrangement that is designed to orient with, engage with, or combinations thereof, said orientation arrangement on said muntin.

12. The insulating unit as defined in claim 1, including a sealing arrangement between said pair of outer sheets and said spacer frame, said sealing arrangement includes a moisture impervious material, a gas impervious material, or combinations thereof.

13. The insulating unit as defined in claim 1, including an insulating gas positioned between said pair of outer sheets.

14. The insulating unit as defined in claim 1, including a desiccant positioned between said pair of outer sheets.

15. The insulating unit as defined in claim 1, wherein said mounting element is designed to substantially cover said base of said spacer frame.

16. A method of making an insulating unit comprising:
a. providing a spacer frame;
b. providing two outer sheets;
c. providing an intermediate sheet;
d. providing a mechanical mounting element;
e. connecting said intermediate sheet to said mechanical mounting element;
f. connecting said mounting element to said spacer frame after said mounting element has been secured to said intermediate sheet and after said spacer frame has been substantially formed into its final square or rectangular form; and,
e. connecting each of said outer sheets to said spacer frame such that said intermediate sheet is positioned between said two outer sheets.

17. The method as defined in claim 16, wherein said spacer frame includes a base and two side walls that extend upwardly from the base to form a channel therebetween, and including the step of at least partially positioning said mounting element in said channel, connecting said mounting member to a top portion of said channel, or combinations thereof.

18. The method as defined in claim 17, including the step of causing at least one side wall of said spacer frame to spring back from an original position and then spring at least partially forward toward the original position as said mounting element is secured to said spacer frame.

19. The method as defined in claim 18, wherein each of said side walls of said spacer frame includes a mounting element connector, said mounting element including two wall connectors, and including the step of causing one wall connector to engage the mounting element connector on one side wall and the other wall connector to engage the mounting element connector on the other side wall as said mounting element is secured to said spacer frame.

20. The method as defined in claim 17, wherein said mounting element is designed to substantially cover a base of said spacer frame.

21. The method as defined in claim 16, wherein said connecting each of said outer sheets to said spacer frame includes positioning said intermediate sheet is between said two outer sheets such that said intermediate sheet is asymmetrically oriented from said two outer sheets.

22. The method as defined in claim 21, wherein said step of connecting or interconnecting said intermediate sheet to said spacer frame includes orienting said intermediate sheet on said spacer frame such that after said outer sheets are connected to said spacer frame, said insulating unit transmits less sound through said insulating unit.

23. The method as defined in claim 17, wherein at least one of said outer sheets, said intermediate sheet, or combinations thereof is a glass sheet.

24. The method as defined in claim 17, wherein said intermediate sheet is thinner than at least one of said outer sheets.

25. The method as defined in claim 17, including the step of positioning a muntin adjacent to said intermediate sheet prior to said outer sheets being connect to said spacer frame so that said intermediate sheet and said muntin are both positioned between said two outer sheets.

26. The method as defined in claim 21, including the step of positioning a muntin adjacent to said intermediate sheet prior to said outer sheets being connected to said spacer frame so that said intermediate sheet and said muntin are both positioned between said two outer sheets.

27. The method as defined in claim 26, wherein said muntin is positioned in a cavity between said pair of outer sheets having a volume that is greater than a volume of at least one other cavity that is positioned between said pair of outer sheets.

28. The method as defined in claim 25, wherein said muntin includes an orientation arrangement that is designed to orient with another arrangement in said insulating unit so as to ensure the proper positioning of said muntin between said pair of outer sheets, the proper physical orientation of said muntin between said pair of outer sheets, the proper side orientation of said muntin between said pair of outer sheets, or combinations thereof, and including the step of properly orienting said muntin in said insulating unit by use of said orientation arrangement on said muntin.

29. The method as defined in claim 28, wherein a mounting element, said spacer frame or combinations thereof includes a muntin orientation arrangement that is designed to orient with, engage with or combinations thereof said orientation arrangement on said muntin, and including the step of properly orienting said muntin in said insulating unit by use of said orientation arrangement on said muntin and said muntin orientation arrangement on said mounting element, said spacer frame or combinations thereof.

30. The method as defined in claim 16, including the step of providing a seal between said outer sheets and said spacer frame, said a seal being moisture impervious seal, a gas impervious seal, or combinations thereof.

31. The method as defined in claim 16, including the step of inserting an insulating gas between said outer sheets.

32. The method as defined in claim 16, including the step of inserting a desiccant between said outer sheets.
